(19) United States
(12) Patent Application Publication
(10) Pub. No.: US 2025/0026891 A1
(43) Pub. Date: Jan. 23, 2025

(54) HYPER-CROSSLINKED POLYMER COMPOUND, PLATINUM GROUP METAL ADSORBENT, METHOD FOR SYNTHESIZING HYPER-CROSSLINKED POLYMER COMPOUND, AND METHOD OF USING HYPER-CROSSLINKED POLYMER COMPOUND AS ADSORBENT

(71) Applicant: Wook Jin Chung, Seoul (KR)

(72) Inventors: Wook Jin Chung, Seoul (KR); Grace NISOLA, Yongin-si (KR); Erwin C. ESCOBAR, Yongin-si (KR)

(21) Appl. No.: 18/748,204

(22) Filed: Jun. 20, 2024

(30) Foreign Application Priority Data
Jun. 21, 2023 (KR) 10-2023-0079831

(51) Int. Cl. C08G 79/08; B01J 20/26

(52) U.S. Cl. CPC C08G 79/08; B01J 20/267; B01J 2220/4812

(57) ABSTRACT

There is provided a hyper-crosslinked polymer compound of thiolated tetraphenylboron.

### CROSS-REFERENCE TO RELATED APPLICATIONS

This application is based on and claims priority from Korean Patent Application No. 10-2023-0079831, filed on Jun. 21, 2023 with the Korean Intellectual Property Office, the disclosure of which is incorporated herein in its entirety by reference.

### STATEMENT DESIGNATING GRACE PERIOD INVENTOR DISCLOSURES

Applicant informs that the subject matter of this design was disclosed by the inventor or joint inventor or by another who obtained the subject matter disclosed directly or indirectly from the inventor or joint inventor one year or less than before the effective filing date of a claimed invention which do not qualify as prior art under 35 USC 102 (b) (1) for the following: GRACE NISOLA, et al., “Hyper-crosslinked tetraphenylboron (TPBx) as a versatile platform material for the development of sorbents for various metal ions”, 2022 AiCHE conference, Nov. 15, 2022, Phoenix Convention Center, Phoenix, AZ USA; and

ERWIN C. ESCOBARA, et al., “Rapid and Selective Recovery of Precious Metals Pd and Pt from Autocatalyst Leachate Using a Novel Polymeric Adsorbent”, 2nd ISEE (International Symposium of Electronic Waste and End-of-Life Vehicles), Nov. 2, 2022, Seoul, Korea.

### Technical Field

The present disclosure relates to a hyper-crosslinked polymer compound, a platinum group metal adsorbent, a method for synthesizing a hyper-crosslinked polymer compound, and a method of using a hyper-crosslinked polymer compound as an adsorbent.

### Background Art

Palladium (Pd) and platinum (Pt) are among the most industrially important metals today due to their widespread use in advanced electronic products, fuel cells, catalysts, and vehicle emission controls. Unfortunately, like all other platinum group metals (PGMs), Pd and Pt are very difficult to obtain naturally and are sparsely distributed in specific geopolitical locations. Demand for more supplies may increase in order to meet industrial production targets, and recovery and recycling of these metals through an urban mining industry paradigm may be the most practical solution in order to meet stringent environmental protection regulations. The urban mining industry approach for replenishing the supply of Pd and Pt in the industry is a logically reasonable approach since PGMs are available in much larger quantities from secondary sources than natural ores. PGMs can be obtained at a concentration of 80 to 130 g ton⁻¹ from electronic waste, 2000 g ton⁻¹ from ceramic bricks of automatic catalytic converters, but only about 10 g ton⁻¹ from natural ores.

Most Pd and Pt are used in the production of automatic catalytic converters in the automotive industry, and this means that deactivated or discarded converters are a rich secondary resource for these metal ions. Unfortunately, PGM recovery and recycling from discarded converters does not seem to have gained sufficient momentum. This may be due to a variety of factors, but the major obstacle will be probably due to the lack of reliable techniques for selective recovery of PGMs from these sources. This is because these materials often contain other nonmetals, making it difficult or impractical to recover PGMs efficiently and selectively. Although it has been shown that they may be selectively recovered using hydrometallurgical technology, the complex process, insufficient recovery, and environmental problems that additionally arise are serious problems that have not yet been solved.

Although there are adsorbents that have been known up to date to have adsorption capacity for Pd and Pt, their potential for effective PGM recovery has not been demonstrated in practical operations. Many of these adsorbents have failed when applied to autocatalyst leachates since Pd and Pt are often present in very low concentrations and are greatly masked by other dissolved metal ions. Additionally, some exceptionally selective adsorbents are very expensive and exhibit insignificant sequestration kinetics.

### DISCLOSURE

### Technical Problem

An object of the present disclosure is to provide a novel hyper-crosslinked polymer compound of thiolated tetraphenylboron.

Another object of the present disclosure is to provide an adsorbent for platinum group metals, comprising the hyper-crosslinked polymer compound of thiolated tetraphenylboron.

A further object of the present disclosure is to provide an adsorbent capable of selective adsorption of platinum group metals.

An even further object of the present disclosure is to provide a method for synthesizing the hyper-crosslinked polymer compound of thiolated tetraphenylboron.

Still yet another object of the present disclosure is to provide a method of using the hyper-crosslinked polymer compound of thiolated tetraphenylboron as an adsorbent.

The objects of the present disclosure are not limited to the objects mentioned above, and other objects and advantages of the present disclosure that are not mentioned can be understood by the following description and will be more clearly understood by embodiments of the present disclosure. Further, it will be readily apparent that the objects and advantages of the present disclosure can be realized by the means and combinations thereof indicated in the patent claims.

### Technical Solution

In one embodiment of the present disclosure, a novel hyper-crosslinked polymer compound of thiolated tetraphenylboron is provided.

The hyper-crosslinked polymer compound of thiolated tetraphenylboron may be one in which a plurality of structural units of Formula 1 below are crosslinked.

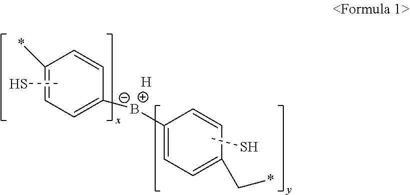

In Formula 1, x and y are each independently an integer of 0 to 4, x+y=4, * represents a bond with * in another neighboring structural units represented by Formula 1 above,

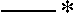

connected to the benzene ring is connected to

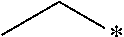 [SMILES: *CC]

connected to the benzene ring of another neighboring structural units represented by Formula 1 above, and

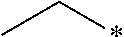

connected to the benzene ring is connected to

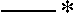 [SMILES: *C]

connected to the benzene ring of another neighboring structural units represented by Formula 1 above.

The hyper-crosslinked polymer compound of thiolated tetraphenylboron may be synthesized by sulfonating a tetraphenylboron hyper-crosslinked polymer to graft a sulfone group, and then substituting the sulfone group with a thiol group.

The hyper-crosslinked polymer compound may be a porous material.

The hyper-crosslinked polymer compound may have a BET surface area of 200 m² g⁻¹ to 1000 m² g⁻¹.

In one embodiment of the present disclosure, a platinum group metal adsorbent containing a hyper-crosslinked polymer compound of thiolated tetraphenylboron may be provided.

The hyper-crosslinked polymer compound of thiolated tetraphenylboron may be one in which a plurality of structural units of Formula 1 are crosslinked.

As the platinum group metal adsorbent, the hyper-crosslinked polymer compound of thiolated tetraphenylboron may perform chemical adsorption.

As the platinum group metal adsorbent, the hyper-crosslinked polymer compound of thiolated tetraphenylboron may perform single layer adsorption.

In one embodiment of the present disclosure, there is provided a method for synthesizing a hyper-crosslinked polymer compound of thiolated tetraphenylboron, the method including steps of:
hyper-crosslinking a tetraphenylboron sodium salt to obtain hyper-crosslinked tetraphenylboron;
sulfonating hyper-crosslinked tetraphenylboron; and
substituting a sulfone group in sulfonated hyper-crosslinked tetraphenylboron with a thiol group to obtain a hyper-crosslinked polymer compound of thiolated tetraphenylboron.

In one embodiment of the present disclosure, a method of using the hyper-crosslinked polymer compound of thiolated tetraphenylboron as an adsorbent is provided.

The method may comprise a step of changing the pH or time conditions during adsorption.

The above method may comprise:
a first step of performing adsorption at a pH of less than 3; and
a second step of performing adsorption at a pH of 3 or more.

The first step may be performed for 5 minutes to 15 minutes, and subsequently the second step may be performed for 30 minutes to 2 hours.

### Advantageous Effects

The hyper-crosslinked polymer compound of thiolated tetraphenylboron can exhibit excellent adsorption performance for Pd²⁺ and Pt⁴⁺ by having a porous structure as a physically and chemically robust structure, having a negative surface charge, being hydrophilic, and containing a soft donor group.

Specific effects of the present disclosure along with the above-described effects are described together below while explaining specific details for carrying out the invention.

### DESCRIPTION OF DRAWINGS

FIGS. 1A and 1B are SEM images of SH-TPBₓ synthesized in Examples, where FIG. 1A is a 5K enlarged SEM image and FIG. 1B is a 20K enlarged SEM image.

FIG. 2 shows particle size distribution obtained by processing the SEM image of SH-TPBₓ synthesized in Examples with imageJ®.

FIG. 3 is a SEM-EDX elemental mapping and quantification image of SH-TPBₓ synthesized in Examples.

FIG. 4 is FTIR spectra of SH-TPBₓ synthesized in Examples.

FIG. 5 is wide scan XPS spectra of SH-TPBₓ synthesized in Examples.

FIG. 6 is a graph measuring surface charges of SH-TPBₓ synthesized in Examples.

FIG. 7 shows N₂ adsorption-desorption isotherms of SH-TPBₓ synthesized in Examples.

FIG. 8 is a graph showing pore size distribution obtained using the NLDFT model for SH—TPBₓ synthesized in Examples.

FIG. 9 is a TGA-DTG curve of SO₃H—TPBₓ under N₂.

FIGS. 10A and 10B are graphs evaluating the adsorption capacities of SH—TPBₓ, where FIG. 10A is a time profile for Pd²⁺ adsorption at a pH of 1 to 4, and FIG. 10B is a time profile for Pt⁴⁺ adsorption at a pH of 1 to 9.

FIGS. 11A and 11B are graphs evaluating the adsorption capacities of SH—TPBₓ, where FIG. 11A is a time profile for Pd²⁺ adsorption and FIG. 11B is a time profile for Pt⁴⁺ adsorption.

FIGS. 12A and 12B are graphs evaluating the adsorption capacities of SH—TPBₓ, where FIG. 12A is an isotherm plot for Pd²⁺ adsorption and FIG. 12B is an isotherm plot for Pt⁴⁺ adsorption.

FIGS. 13A and 13B are graphs evaluating the adsorption capacities of SH—TPBₓ at different temperatures, where FIG. 13A is a graph for Pd²⁺ and FIG. 13B is a graph for Pt⁴⁺.

FIGS. 14A and 14B show results of the van′t Hoff equation in which the adsorption capacity data is linearized.

FIGS. 15A and 15B show Dubinin-Radushkevich plots.

FIGS. 16A and 16B are graphs evaluating the adsorption-desorption capacity, FIG. 16A is a graph evaluating the adsorption-desorption capacity of five reuse cycles on single metal ion feed solutions comprising Pd²⁺ (up to 126.23 mg/L-1 at pH 1) and FIG. 16B is a graph evaluating the adsorption-desorption capacity of five reuse cycles on single metal ion feed solutions comprising Pt⁴⁺ (up to 83.49 mg/L⁻¹ at a pH of 4).

FIG. 17A shows a concentration profile of metal ions in simulated autocatalyst leachate comprising Pd²⁺, Pt⁴⁺, Fe³⁺, and Ce³⁺ after adsorption using different doses (mg/mL⁻¹) of SH—TPBₓ at a pH of 1; and FIG. 17B shows a concentration profile of metal ions in simulated autocatalyst leachate comprising Pt⁴⁺, Fe³⁺, and Ce³⁺ after adsorption using different doses (mg/mL⁻¹) of SH—TPBₓ at a pH of 3.

FIG. 18A shows a process flow proposed for two-stage batch recovery operation and FIG. 18B shows concentration profiles of metal ions in simulated autocatalyst leachate containing Pd²⁺, Pt⁴⁺, Fe³⁺, and Ce³⁺ after performing adsorption at a pH of 1 for 20 minutes (step 1) and after performing adsorption at a pH of 3 for 60 minutes (step 2).

FIG. 19 is FTIR spectra and SEM images of the pristine state and regenerated SH—TPBₓ after the 5th adsorption-desorption cycle.

FIGS. 20A and 20B show distribution coefficient (K_{D}) profiles of metal ions in SH—TPBₓ applied to simulated autocatalyst leachates after performing adsorption at a pH of 1 for 20 minutes at S/L=8 (FIG. 20A) and after performing adsorption at a pH of 3 for 60 minutes at S/L=8 (FIG. 20B).

### MODE FOR DISCLOSURE

The above-described objects, features, and advantages will be described in detail later, and accordingly those skilled in the art to which the present disclosure pertains will be able to easily implement the technical idea of the present disclosure. In describing the present disclosure, if it is determined that a detailed description of known technologies related to the present disclosure may unnecessarily obscure the substance of the present disclosure, the detailed description will be omitted. Hereinafter, preferred embodiments according to the present disclosure will be described in detail with reference to the accompanying drawings.

In one embodiment of the present disclosure, there is provided a hyper-crosslinked polymer compound of thiolated tetraphenylboron.

The hyper-crosslinked polymer compound of thiolated tetraphenylboron has a plurality of structural units of Formula 1 below crosslinked.

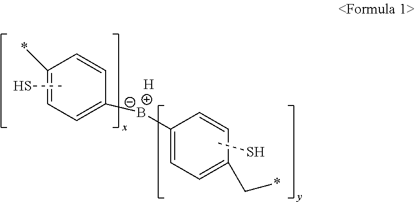

In Formula 1, x and y are each independently an integer of 0 to 4, x+y=4, * represents a bond with * in another neighboring structural units represented by Formula 1 above,

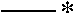

connected to the benzene ring is connected to

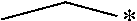 [SMILES: *CC]

connected to the benzene ring of another neighboring structural units represented by Formula 1 above, and

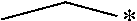

connected to the benzene ring is connected to

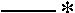 [SMILES: *C]

connected to the benzene ring of another neighboring structural units represented by Formula 1 above.

The benzene ring in Formula 1 above is connected to a benzene ring in another neighboring structural units represented by Formula 1 above through methylene. That is, it is connected in a form where a methylene linker exists between two benzene rings. In this way, the hyper-crosslinked polymer compound is formed while the four benzene rings connected to boron are being each connected to any one of the four neighboring benzene rings connected to boron to form a hyper-crosslinked structure as a network structure.

The hyper-crosslinked polymer compound can withstand highly acidic conditions due to its hyper-crosslinked nature and can preserve its adsorption properties even after several desorption and reactivation cycles.

The hyper-crosslinked polymer compound is formed of a porous material. The hyper-crosslinked polymer compound mainly comprises micropores and mesopores.

In one embodiment, the hyper-crosslinked polymer compound has a BET surface area of 200 m² g⁻¹ to 1000 m² g⁻¹.

The hyper-crosslinked polymer compound has an advantage in that countless functional modifications are possible since its chemical structure is mainly composed of benzene moieties.

When the hyper-crosslinked polymer compound of thiolated tetraphenylboron is applied as an adsorbent for platinum group metals (PGMs) such as Pd and Pt, the platinum group metal (PGMs) may be recovered by adsorption. Such an adsorption technology is simple and generally operates environmentally safely.

The hyper-crosslinked polymer compound of thiolated tetraphenylboron can exhibit excellent adsorption performance for Pd²⁺ and Pt⁴⁺ by having a porous structure as a physically and chemically robust structure, having a negative surface charge, being hydrophilic, and containing a soft donor group.

The hyper-crosslinked polymer compound may be synthesized by sulfonating a tetraphenylboron hyper-crosslinked polymer, grafting a sulfone group, and then substituting the sulfone group with a thiol group. In one embodiment, the hyper-crosslinked polymer compound may be synthesized from the tetraphenylboron hyper-crosslinked polymer by Reaction Formula 1 below.

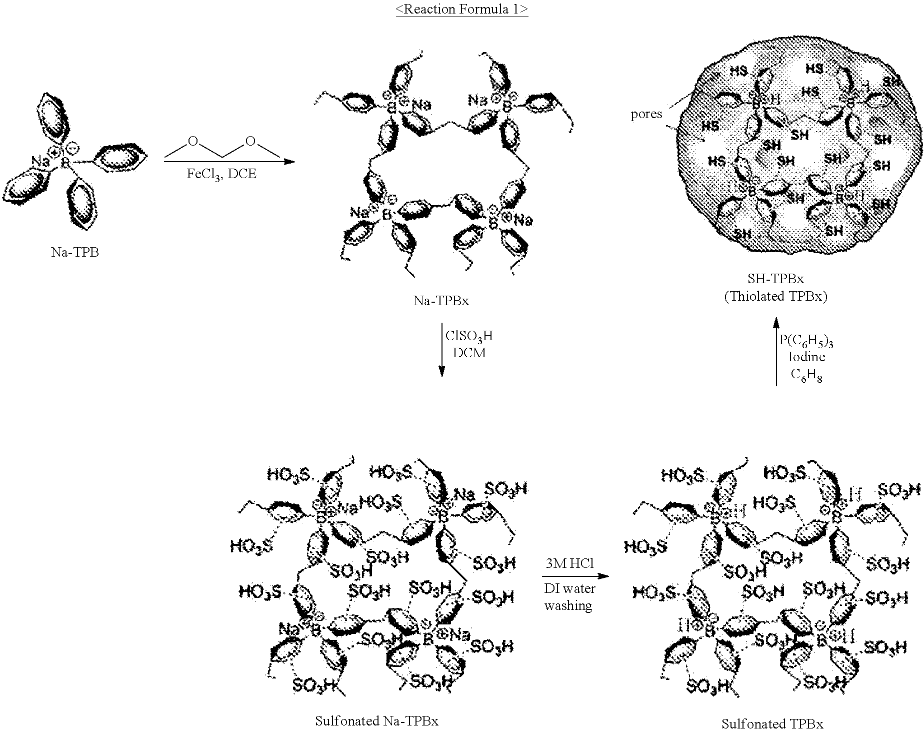

In Reaction Formula 1, a hyper-crosslinked polymer (TPBₓ) of tetraphenylboron is grafted with a sulfonic acid group to prepare a sulfonated form, SO₃H—TPBₓ. Subsequently, the sulfonic acid group is reduced from benzene to triphenylphosphine and iodine and changed to thiol, thereby producing a thiolated form, that is, the hyper-crosslinked polymer compound (SH—TPBₓ) of thiolated tetraphenylboron. The hyper-crosslinked polymer compound of thiolated tetraphenylboron may effectively and efficiently isolate and recover platinum group metals (PGMs) such as Pd and Pt.

In one embodiment of the present disclosure,
there is provided a method for synthesizing a hyper-crosslinked polymer compound of thiolated tetraphenylboron, the method comprising steps of:
hyper-crosslinking a tetraphenylboron sodium salt to obtain hyper-crosslinked tetraphenylboron;
sulfonating hyper-crosslinked tetraphenylboron; and
substituting a sulfone group in sulfonated hyper-crosslinked tetraphenylboron with a thiol group to obtain a hyper-crosslinked polymer compound of thiolated tetraphenylboron.

The hyper-crosslinked polymer compound of thiolated tetraphenylboron provides usages as an adsorbent capable of designing the adsorption order of the adsorption target metal, etc.

according to adjustment of excellent levels of adsorption performance and adsorption conditions for platinum group metals (PGMs) in an autocatalyst leachate.

The hyper-crosslinked polymer compound of thiolated tetraphenylboron may exhibit a negative surface charge, for example, −5 mV to −40 mV, in a wide pH range. This means that the hyper-crosslinked polymer compound of thiolated tetraphenylboron may interact well with cations in both acidic and alkaline aqueous conditions.

In one embodiment, the hyper-crosslinked polymer compound of thiolated tetraphenylboron performs chemical adsorption.

In one embodiment, the hyper-crosslinked polymer compound of thiolated tetraphenylboron performs single layer adsorption.

In one embodiment, the hyper-crosslinked polymer compound of thiolated tetraphenylboron has a distribution coefficient (K_{D}) for Pd metal of 4000 to 6000 under pH 1 conditions, and a distribution coefficient (K_{D}) for Pt metal of 20,000 to 30,000 under pH 3 conditions. The hyper-crosslinked polymer compound of thiolated tetraphenylboron exhibits very excellent adsorption performance that is difficult to exhibit in polymer adsorbents. The reason for the low adsorption performance of known polymer adsorbents is that there is a problem in poor sorbent-sorbate interaction. The unusual physico-chemical properties of the hyper-crosslinked polymer compound of thiolated tetraphenylboron allow the disadvantages of conventional polymer adsorbents to be effectively overcome by easily and efficiently flowing the aqueous medium into the polymer matrix. Since Pd²⁺ and Pt⁴⁺ are generally present in low concentrations in autocatalyst leachate, the adsorption capacity of sorbate concentration diluted in practical applications is highly required, and the hyper-crosslinked polymer compound of thiolated tetraphenylboron may act effectively as an adsorbent in these cases.

From the experimental maximum adsorption capacity evaluation of the hyper-crosslinked polymer compound of thiolated tetraphenylboron (SH—TPBₓ) in Examples described below, it is understood that the adsorption of Pd²⁺ occurs through various mechanisms: (1) two adjacent sulfur atoms (—S:Pd²⁺:S—) form a complex with a thiol group participating in two lone pairs of electrons; (2) complex formation with two pairs of phenyl rings from two adjacent tetraphenylboron (TPB) moieties (—Ph₂—B⁻—Ph₂—Pd²⁺—Ph₂—B⁻—Ph₂—); and (3) complex formation with adjacent sulfur and tetraphenylboron (TPB) moieties (—S: Pd²⁺—Ph₂—B⁻—Ph₂—).

The adsorbent may be reused by being recyclable as a lixiviant.

For example, the lixiviant may comprise thiourea and the like, but is not limited thereto. For example, the lixiviant may comprise a 1 M thiourea solution in hydrochloric acid as a lixiviant during desorption, the pH conditions may be adjusted together when desorbing each metal, and for example, desorption of Pd may be performed at a pH of 2, and desorption of Pt may be performed at a pH of 4.

In one embodiment of the present disclosure, there is provided a method of using the hyper-crosslinked polymer compound of thiolated tetraphenylboron as an adsorbent.

The above method may enable selective recovery of platinum group metals sequentially by type by adjusting the adsorption conditions, thereby allowing adsorption to be performed sequentially according to the conditions for each type. The selective recovery means half or more of the mass of the major adsorption target metal, that is, the adsorption target metal. For example, Pd ions and Pt ions may be selectively and sequentially recovered by adjusting pH, contact time, and the like during adsorption, and such PGMs may be substantially completely recovered by sequentially performing appropriate adsorption conditions.

It is understood that the adsorption saturation time for Pd²⁺ of the above adsorbent is the fastest among known adsorbents. These results may be due to several key factors related to the morphology and chemistry of the hyper-crosslinked polymer compound of thiolated tetraphenylboron. First, the hyper-crosslinked polymer compound of thiolated tetraphenylboron is hydrophilic and highly porous by having a large surface area. This means that sorbent-sorbate interactions occur rapidly and extensively in aqueous media. Second, due to the negative surface charge, it attracts cations such as Pd²⁺ and Pt⁴⁺, making it electrically suitable for complexation reaction with thiol groups.

In one embodiment, the method may comprise a step of sequentially changing the pH.

For example, for sequential recovery of Pd²⁺ and Pt⁴⁺, the method may comprise a first step of performing adsorption at a pH of less than 3, e.g., a pH of 0.5 to 2.5, and a second step of performing adsorption at a pH of 3 or more, e.g., a pH of 3 to 9. Specifically, the first step may be performed for 5 minutes to 15 minutes, e.g., 5 minutes to 10 minutes, and the second step may be performed for 30 minutes to 2 hours, specifically 45 minutes to 60 minutes.

The fact that the hyper-crosslinked polymer compound of thiolated tetraphenylboron exhibits an imbalance between the adsorption rates for Pd²⁺ and Pt⁴⁺ may be due to the adsorption mechanism. Since Pd²⁺ requires only two electron-donating groups (e.g., thiols) to fulfill the complexing requirements, the coordination sphere is completed more easily, whereas Pt⁴⁺ requires more. This imbalance in adsorption kinetics enables strategic design for sequential recovery of Pd²⁺ and Pt⁴⁺. In one embodiment, when Pd²⁺ and Pt⁴⁺ are present in a mixture such as an autocatalyst leachate, after the hyper-crosslinked polymer compound of thiolated tetraphenylboron is dispersed in the mixture, the hyper-crosslinked polymer compound of thiolated tetraphenylboron collected after adsorption within the first 10 minutes is expected to comprise a much larger amount of Pd²⁺than Pt⁴⁺. A second batch of SH—TPBₓ dispersed in the remaining mixture will isolate the remaining Pt⁴⁺ for 60 minutes. This selective recovery may be achieved by temporarily adjusting the adsorption process. As a method of controlling the time conditions combined with pH shift in a two-stage batch process, noble metal ions may be substantially completely recovered from the autocatalyst leachate through adsorption using the hyper-crosslinked polymer compound of thiolated tetraphenylboron.

Hereinafter, Examples and Comparative Examples of the present disclosure will be described. The following Examples are only an example of the present disclosure, and the present disclosure is not limited to the following Examples.

### EXAMPLES

### Example 1

### Chemicals and Reagents

Sodium tetraphenylborate (NaTPB, ACS reagent), dimethoxymethane (99.5+% DMM), 1,2-dichloroethane (99.8% DCE), and triphenylphosphine (99%): manufactured by Acros Organics

### (Belgium).

Chlorosulfonic acid, cerium (III) chloride heptahydrate (99.5%), palladium (II) nitrate dihydrate (based on 40% Pd), and platinum (IV) chloride (99.9%): purchased from Sigma-Aldrich (Korea).

Dichloromethane (99.8% CH₂Cl₂), methanol (99.9% MeOH), chloroform (99.5% CHCl₃), acetone (99.5% C₃H₆O), benzene (99.5% C₆H₆), iron (III) chloride anhydrous, and hydrochloric acid (>36% RHM grade HCl): manufactured by Samchun Chemicals Co., Ltd. (Korea).

Nitric acid (70% RHM grade HNO₃): manufactured by DaeJung Chemicals and Metals (Korea).

Iodine (>99%): manufactured by Kanto Chemical Company, Inc. (Japan).

Deionized water (DI) (18.2 mΩ·cm⁻¹ at 25° C.): processed through Millipore Milli-Q system.

### Synthesis of sulfonated hyper-crosslinked tetraphenylboron (SO₃H—TPBₓ)

Hyper-crosslinked tetraphenylboron (Na-TPBₓ) was synthesized in DCE using NaTPB as a monomer and DMM as a crosslinker (see Reaction Formula 1 above). The sulfonation of hyper-crosslinked tetraphenylboron (TPBₓ) was carried out by first dispersing TPBₓ (1.0 g) in DCM (10 mL) for about 3 hours to allow the polymer to swell, and then mixing it with chlorosulfonic acid (10 mL) at 25° C. for 12 hours. After quenching the reaction by slowly adding deionized water (500 mL), the mixture was filtered to collect sulfonated hyper-crosslinked tetraphenylboron (SO₃H-TPBₓ). Sulfonated hyper-crosslinked tetraphenylboron (SO₃H—TPBₓ) was washed sequentially with chloroform, methanol, and deionized water and then vacuum-dried at 60° C. overnight to remove excess reagents.

### Synthesis of thiolated tetraphenylboron hyper-crosslinked polymer compound (SH-TPBₓ)

Sulfonated hyper-crosslinked tetraphenylboron (SO₃H—TPBₓ) (0.5 g) was stirred in benzene (200 mL) for 20 minutes to allow the polymer to disperse and swell in the solvent. Afterwards, iodine (0.311 g) and triphenylphosphine (4.823 g) were added. The mixture was stirred at reflux under nitrogen atmosphere for 6 hours. A thiolated tetraphenylboron hyper-crosslinked polymer compound (SH—TPBₓ) was collected by filtration and then washed with benzene, methanol, and deionized water. Before the adsorption experiment, the thiolated tetraphenylboron hyper-crosslinked polymer compound (SH—TPBₓ) was washed in 3M HCl for 24 hours to remove pre-adsorbed metal ions, and then washed repeatedly with deionized water until it became neutral runoff. Finally, the thiolated tetraphenylboron hyper-crosslinked polymer compound (SH—TPBₓ) was dried under vacuum at 60° C. overnight.

### (Evaluation)

Characteristics of thiolated tetraphenylboron hyper-crosslinked polymer compound (SH—TPBₓ)

The surface morphology of SH—TPBₓ was visualized and the approximate elemental composition was estimated through scanning electron microscopy and energy-dispersive X-ray spectroscopy (SEM-EDX, Hitachi S-3500 N, Japan). SH—TPBₓ mixtures in deionized water (S/L=1.0) at different pHs were used to measure surface charge at 25° C. using a Zetasizer Nano ZS (Malvern Instruments Ltd., UK). Functional groups were measured by Fourier transform infrared spectroscopy (FTIR, Thermo Scientific, Nicolet 4 iS5), pore properties were obtained through N₂ adsorption-desorption at 77 K(BELSORP-mini X, BEL Japan Inc., Japan), and an appropriate method was used to determine surface area (Brunauer-Emmett-Teller, BET) and pore size distribution (Non-Local Density Functional Theory model, NLDFT). Thermal stability was assessed through thermogravimetric analysis (TGA, Mettler Toledo DSC 3, Australia) in N₂ atmosphere at 10° C. min⁻¹. The surface composition of SH—TPBₓ was evaluated using high-performance X-ray photoelectron spectroscopy (HPXPS, Thermo Fisher Scientific K-Alpha+XPS System, UK) on a monochromatic Al Kα X-ray source (1486.6 eV) operating at 12 kV/72 W.

The bulk density (pSH—TPBₓ) of SH—TPBₓ was measured at 25° C. using a 25 mL pycnometer having a thermometer (Witeg, Germany) mounted thereon. If V_{TPB-X} was the inverse of SH—TPBₓ and Vₚₒᵣₑ was the specific pore volume determined from the N₂ adsorption-desorption results, the porosity of SH—TPBₓ was estimated as % P=Vₚₒᵣₑ/(V_{TPB-X}+Vₚₒᵣₑ)×100. The water absorption rate was calculated using the weight (w2) and dry weight (w1) of SH—TPBₓ after immersion in water for 1 hour in the equation % Wᵤₚₜₐₖₑ=(w2−w1)/w1×100.

### Batch Adsorption Experiment

Single metal ion solutions of Pd and Pt were used to evaluate the effects of feed pH, contact time (kinetics), feed concentration (isotherm), and temperature (thermodynamics) on the adsorption capacity at an adsorbent dose of 1 g L⁻¹. Feed pH was adjusted using 1M HNO₃ or 1M NaOH. The adsorption capacity after t minutes was calculated as qₜ in Equation 1, and the equilibrium adsorption capacity at different feed concentrations was calculated as qₑ in Equation 2. Cyclic adsorption-desorption operation was performed at an adsorbent dose of 1 g L⁻¹ using 1 M thiourea in 2 M HCl as a lixiviant, and the amount of desorbed metal was calculated by q_{des} in Equation 3. Here, C_{des} is the concentration of metal ions leached together with a predetermined volume (V_{des}) of the lixiviant. Other adsorbent evaluation parameters such as desorption (Equation 4) and removal (Equation 5) efficiencies and distribution coefficient (K_{D} in Equation 6) were estimated using experimental data.

$$\begin{matrix}{q}_{t} = \frac{( {C}_{o} - {C}_{t} ) V}{m} & ( 1 ) \\ {q}_{e} = \frac{( {C}_{o} - {C}_{e} ) V}{m} & ( 2 ) \\ {q}_{des} = \frac{{C}_{des} {V}_{des}}{m} & ( 3 ) \\ \% Desorption = \frac{{q}_{des}}{{q}_{ads}} \times 100 & ( 4 ) \\ \% Removal = \frac{{C}_{o} - {C}_{e}}{{C}_{o}} \times 100 & ( 5 ) \\ {K}_{D} = \frac{q}{{C}_{e}} & ( 6 )\end{matrix}$$

### Analysis Method

A pH probe/meter (Orion 4-Star, SNB0031, USA) was used in order to monitor and measure the pH of the liquid mixture. Metal ion concentrations were quantified through inductively coupled plasma mass spectrometry (ICP-MS Agilent 7500 series, USA) using appropriate calibration standards. Prior to ICP-MS analysis, liquid samples were subjected to filtration (0.2 μm nylon membrane) and heat-controlled acid digestion (MARS-5 CEM, USA) in metal-free nitric acid.

### (Evaluation Results)

### Characteristics of SH—TPBₓ

Dry SH—TPBₓ appeared as loose brown particulates that were readily dispersed in water but eventually settled if undisturbed.

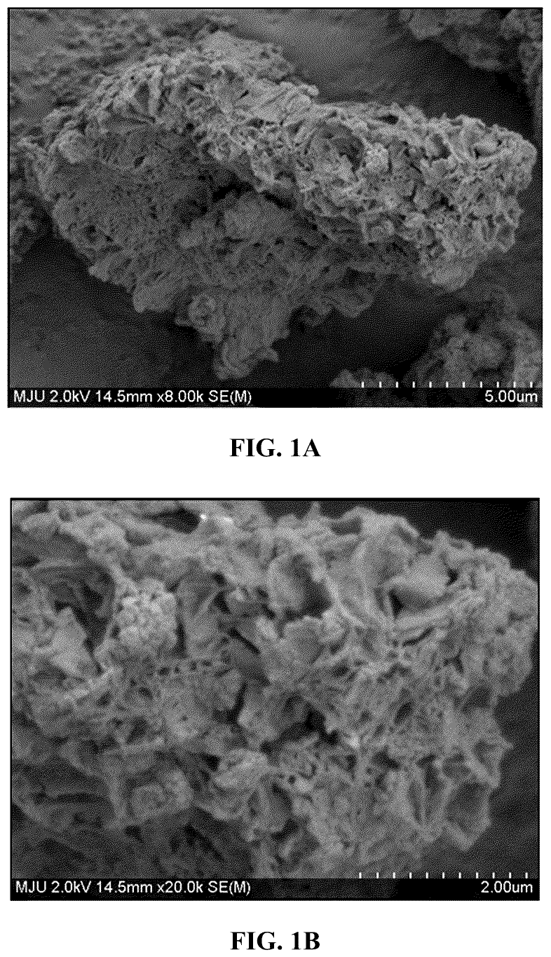

FIG. 1 is SEM images of SH—TPBₓ, where FIG. 1A is a 5K enlarged SEM image and FIG. 1B is a 20K enlarged SEM image. It shows that SH-TPB is highly porous and has an irregular shape with rough surface features due to its sponge-like structure.

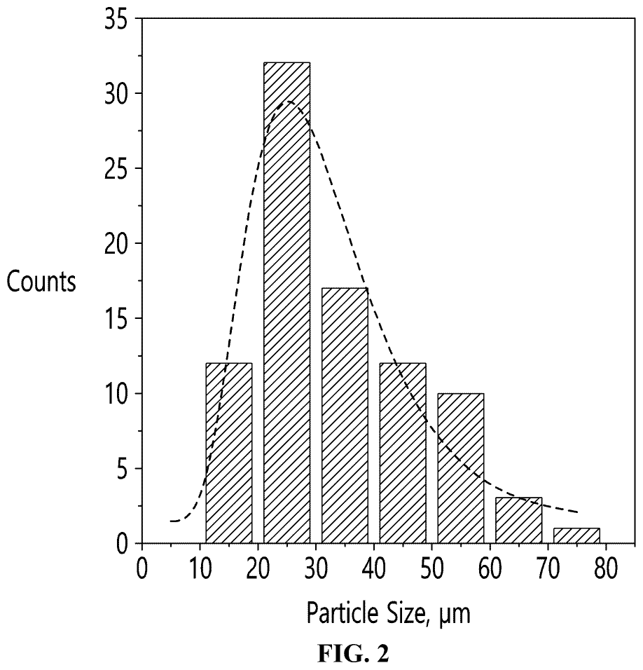

FIG. 2 shows particle size distribution obtained by processing the SEM image with imageJ®. It shows that the average particle diameter of SH—TPBₓ as lognormal fitting of the particle size histogram was φave=29.4 μm.

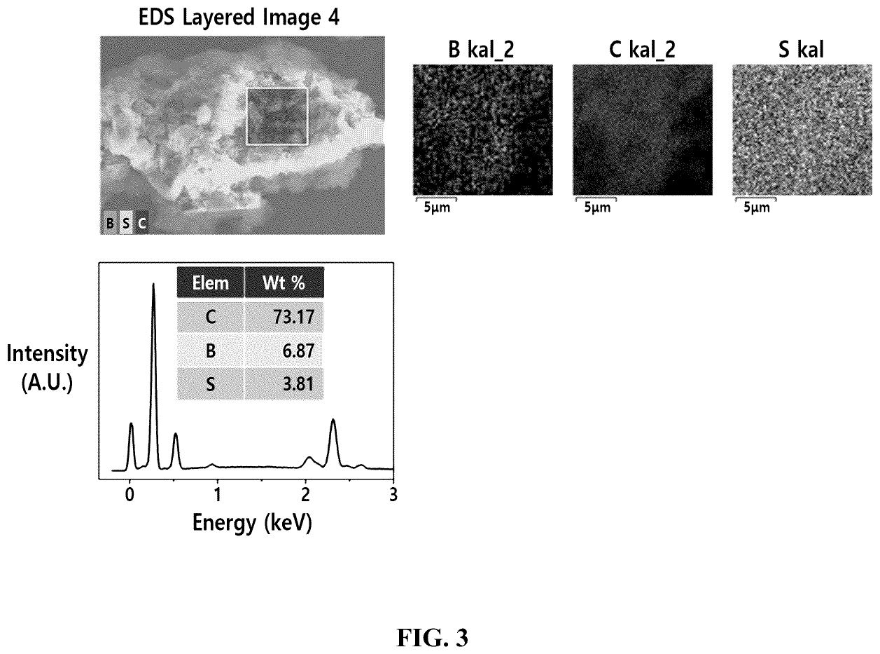

FIG. 3 is a SEM-EDX elemental mapping and quantification image. Elemental surface scan of SH—TPBₓ shows the presence of O (12.32%), which can be mainly attributed to moisture combined with C (83.92%), B (1.24%), and S (2.53%) that make up the polymer structure. According to elemental analysis, SH—TPBₓ contains approximately 7.244% S, which translates to a thiol load of 2.253 mmol g⁻¹. Assuming a uniform distribution of thiol groups in SH—TPBₓ, this thiol load corresponds to one thiol group per TPB monomer.

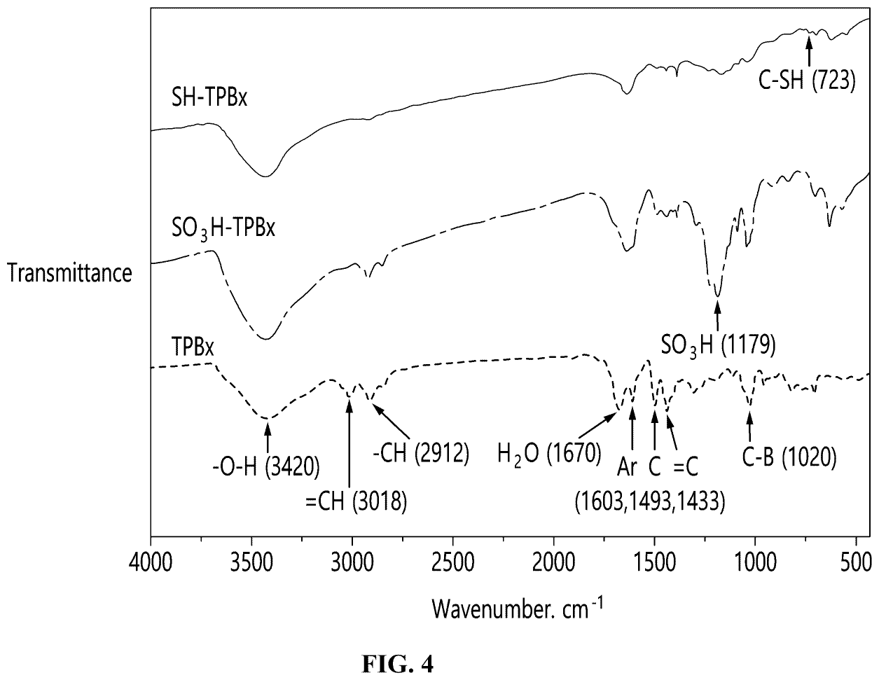

FIG. 4 is FTIR spectra. SH—TPBₓ is characterized by the appearance of a weak S—H vibration band at 723 cm⁻¹ and the loss of the S═O stretching vibration at 1179 cm⁻¹ present in the precursor SO₃H—TPBₓ. These results confirm that the sulfonic acid group was successfully converted to a thiol group after the reduction reaction. Meanwhile, a vibrational signal related to captive moistures (3420 to 3436 cm⁻¹, 1630 to 1670 cm⁻¹), phenyl ring (1383 to 1603 cm⁻¹), and C—B binding (1020 to 1037 cm⁻¹) existing in the FTIR spectra of precursor polymers TPBₓ and SO₃H-TPBₓ is also present in SH—TPBₓ.

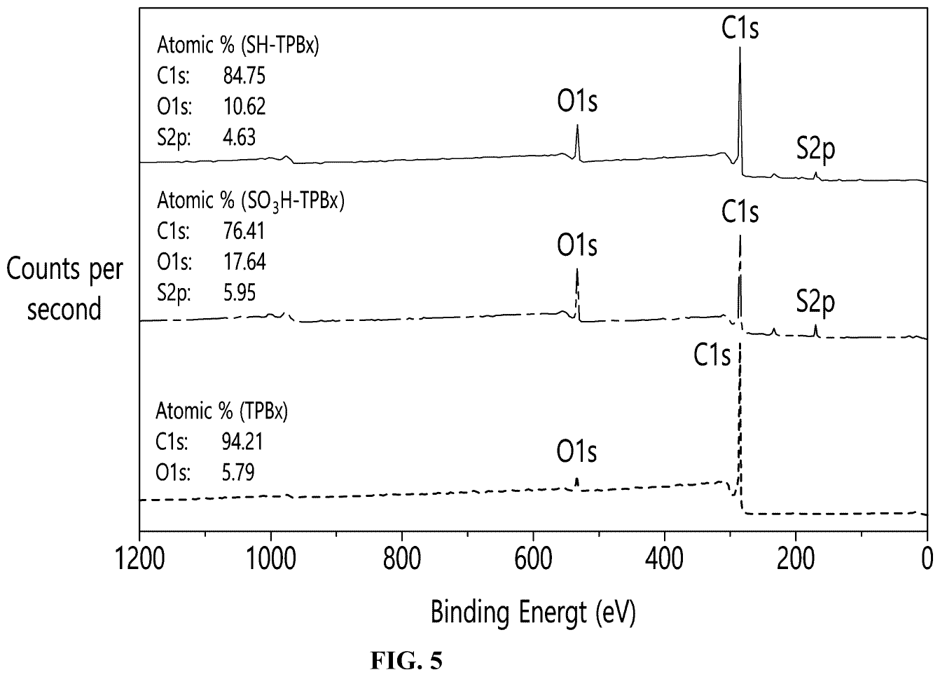

FIG. 5 is wide scan XPS spectra. Elemental investigation obtained through X-ray photoelectron spectroscopy confirmed the presence of sulfur moieties in both SO₃H—TPBₓ and SH—TPBₓ along with the appearance of S2p signal, which is not present in TPBₓ. In addition, the low oxygen ratio of SH—TPBₓ (O1s, 10.62%) compared to SO₃H—TPBₓ (O1s, 17.64%) was consistent with the reduction of oxygen-rich sulfonic acid groups to thiols. Overall, these results confirmed the successful synthesis of SH—TPBₓ.

In Table 1, the bulk density of SH—TPBₓ is β_{bulk}=1.44 g cm⁻³, which corresponds to a porosity of 57% using Vₚₒᵣₑ=0.9165 cm³g⁻¹. The moisture absorption capacity is Wᵤₚₜₐₖₑ=154%, which is due to the hydrophilic nature and sponge-like structure that facilitates water inflow into the highly porous matrix.

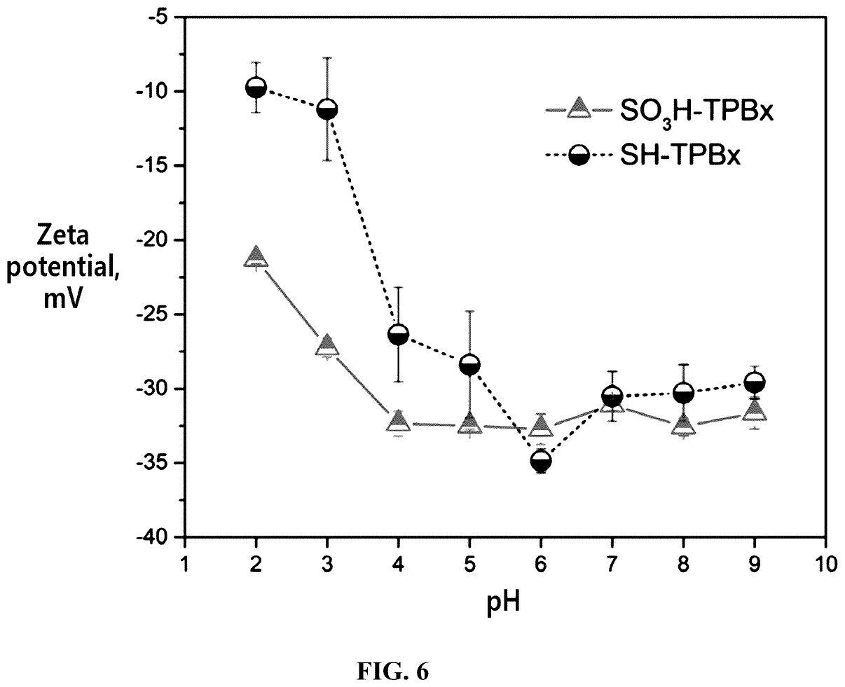

FIG. 6 is a graph measuring surface charges. Like the sulfonated precursor, SH—TPBₓ exhibits negative surface charges (−10 mV to −30 mV) in a wide pH range (pH 2 to 9).

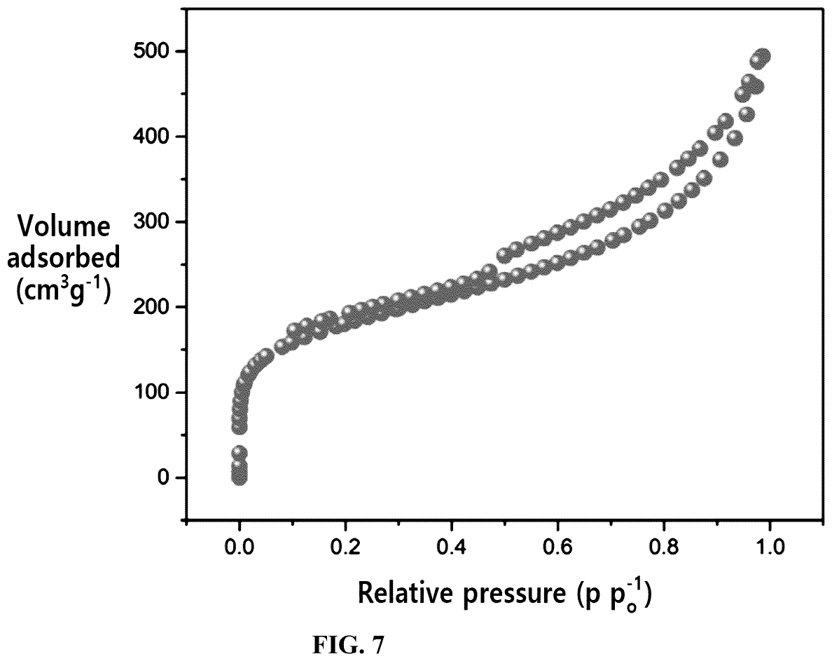

FIG. 7 shows N₂ adsorption-desorption isotherms of SH—TPBₓ. FIG. 7 characterizes the narrow hysteresis loop characteristics of the type IV-H₄ isotherm. This isotherm indicates the presence of micropores (φₚₒᵣₑ<2 nm) and mesopores (2 nm<φₚₒᵣₑ<50 nm), which are 0.2080 cm³ g⁻¹ and 0.5914 cm³ g⁻¹, respectively, based on NLDFT measurements.

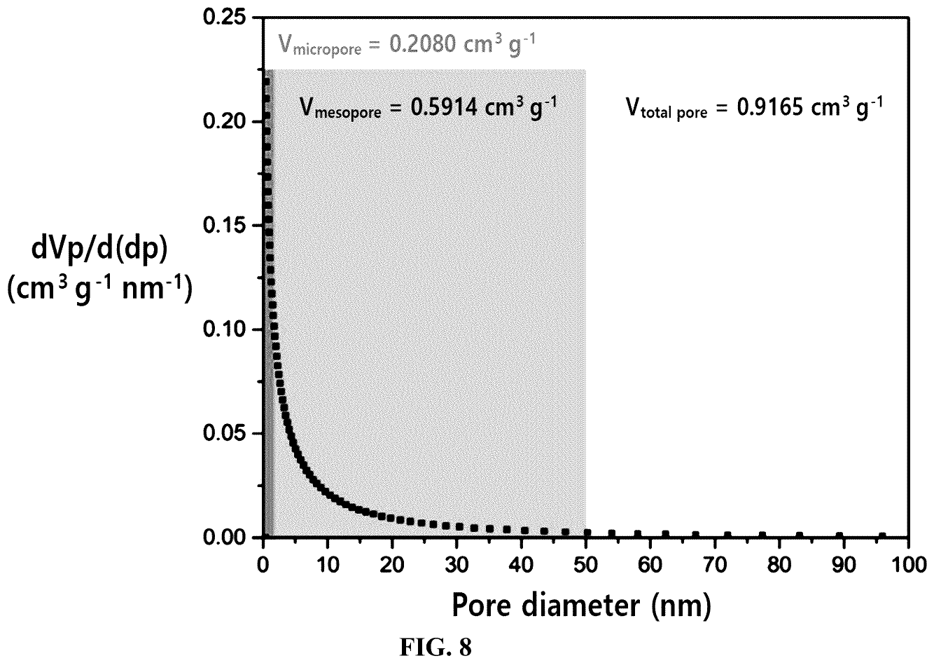

FIG. 8 is a graph showing pore size distribution obtained using the NLDFT model. The BET surface area of SH—TPBₓ is 643.47 m²g⁻¹, which is lower than that of the starting material TPBₓ (1030 m²g⁻¹). The reduction in surface area is of course the result of the thiol groups creating an additional layer of material on TPBₓ, effectively narrowing the pores and reducing the amount of exposed surface.

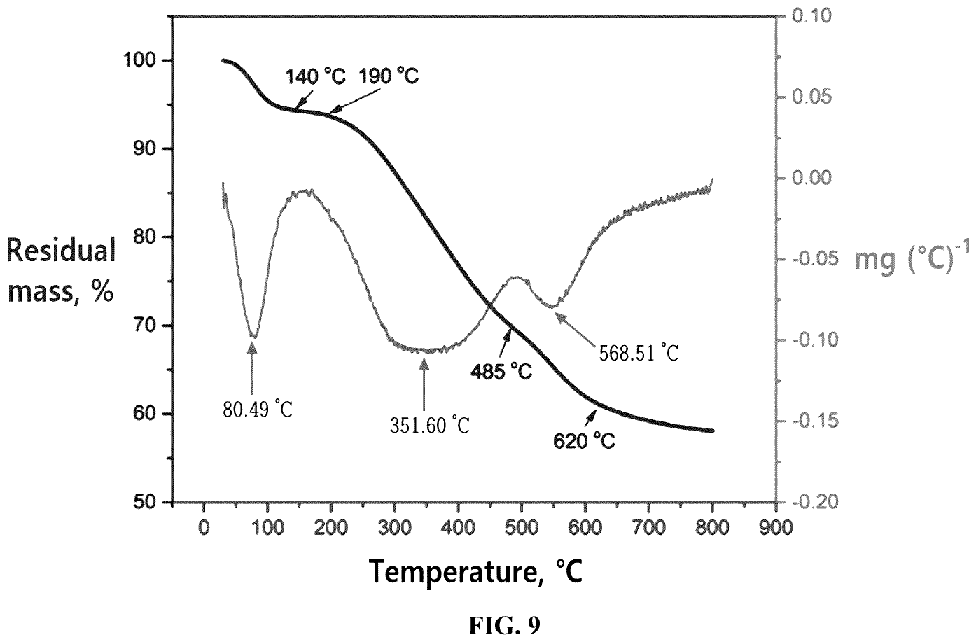

FIG. 9 is a TGA-DTG curve of SO₃H—TPBₓ under N₂. Thermal decomposition profile of SH—TPBₓ in N₂ indicates three distinct mass loss events that may be attributed to release of bound moisture (60 to 140° C.), cleavage of thiol group (190 to 485° C.), and decomposition of carbon chain (485 to 620° C.). Each event peaks at 80.49° C., 351.60° C., and 568.51° C., respectively. These results suggest that SH—TPBₓ may be expected to be thermally stable within the temperature conditions of typical adsorption operations.

TABLE 1

| Physical properties | Values |
|---|---|
| ∅ave (μm) | 29.4 |
| Vₚₒᵣₑ (cm³ g⁻¹) | 0.9165 |
| Pbulk (g cm⁻³) | 1.44 |
| % P | 57 |
| SABER (m² g⁻¹) | 643.47 |
| Wuptake (%) | 154% |

### Adsorption Performance Evaluation Results

(Evaluation of Pd²⁺ and Pt⁴⁺ Sequestration According to pH Change)

The adsorption capacities of SH—TPBₓ for Pd²⁺ and Pt⁴⁺ at different pHs were evaluated in pH-adjusted single metal ion feed solutions using 1M HNO₃ or 1M NH₄OH.

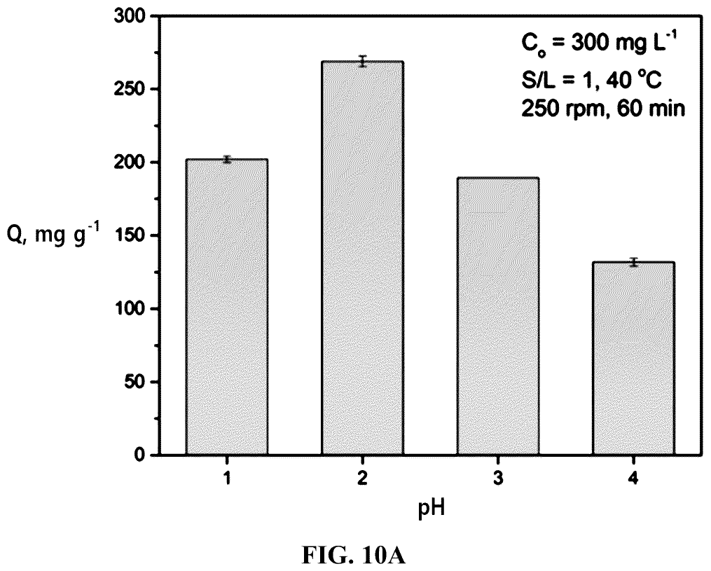

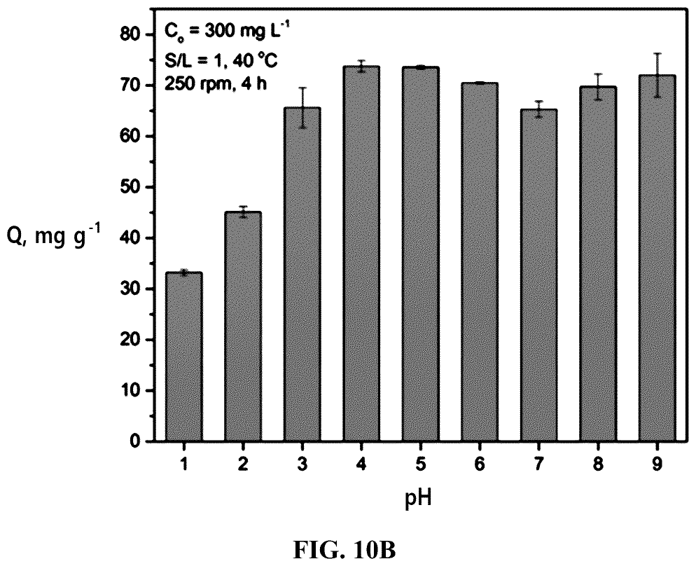

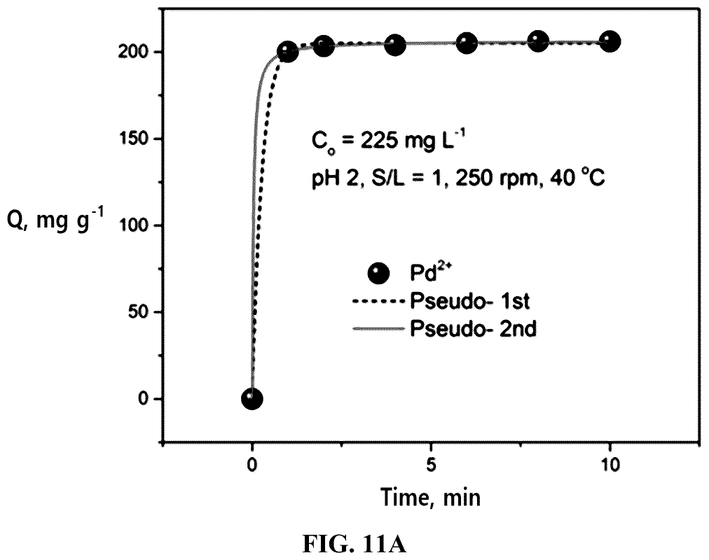

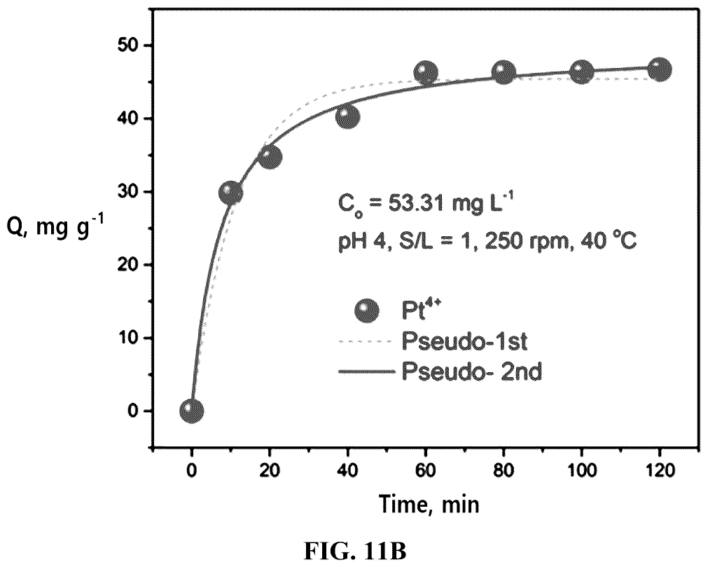

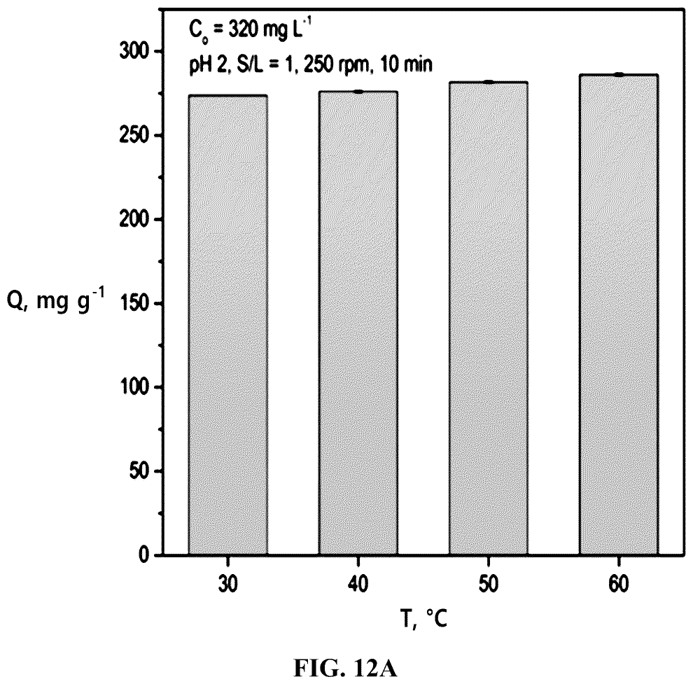

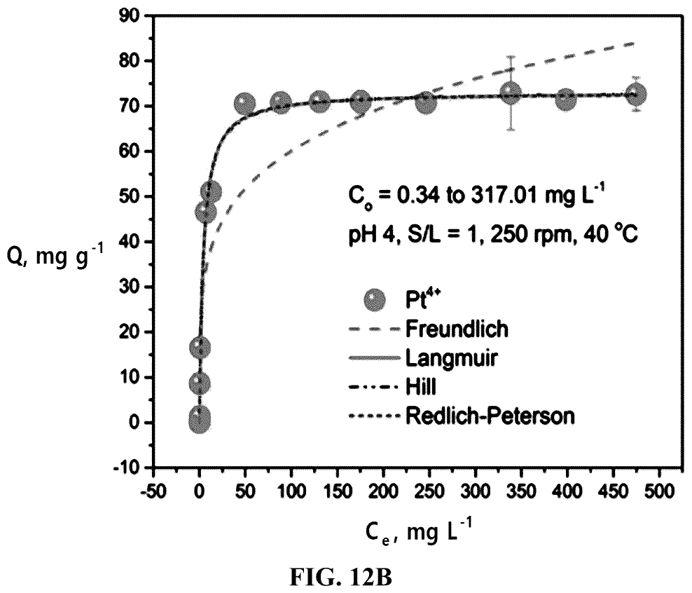

FIGS. 10A to 12B are graphs evaluating the adsorption capacities of SH—TPBₓ. FIG. 10A is the time profile for Pd²⁺ adsorption at a pH of 1 to 4, FIG. 10B is the time profile for Pt⁴⁺ adsorption at a pH of 1 to 9, FIG. 11A is the time profile for Pd²⁺ adsorption, FIG. 11B is the time profile for Pt⁴⁺ adsorption, FIG. 12A is an isotherm plot for Pd²⁺ adsorption, and FIG. 12B shows an isotherm plot for Pt⁴⁺ adsorption.

[General conditions: S/L=1.0, 250 rpm, 40° C.; Effect of pH for 24 hours; Kinetic runs were performed at a pH of 2 and Co ˜ 225 mg L⁻¹ for Pd²⁺ and at a pH of 4 and Co ˜ 53.31 mg L⁻¹ for Pt⁴⁺. Isotherm runs were performed at a pH of 2 for 10 min in Co ˜ 0.5 to 755 mg L⁻¹ for Pd²⁺ and at a pH of 4 for 60 min in Co ˜ 0.34 to 317.01 mg L⁻¹ for Pt⁴⁺.]

Adsorption experiments were performed at pH conditions where the target metal exists as dissolved ions, i.e., a pH of 1 to 4 for Pd²⁺ and a pH of 1 to 9 for Pt⁴⁺. The results showed that SH—TPBₓ adsorbed Pd²⁺ and Pt⁴⁺ at all pH conditions considered (FIGS. 10A and 10B). Moreover, the adsorption capacity for Pd²⁺ at a pH of 1 to 2 was significantly higher than that at a pH of 3 to 4 (FIG. 10A). Meanwhile, the adsorption capacity for Pt⁴⁺ at a pH of 1 to 2 is significant but relatively lower than that at a pH of 3 to 9 (FIG. 10B). These results suggest the possibility of a sequential recovery process for Pd²⁺ and Pt⁴⁺ through a simple pH shift, which could be achieved quite successfully when Pd²⁺ was first recovered at a pH of 1 and then Pt⁴⁺ was recovered in simulated autocatalyst leachate at a pH of 3.

### (Adsorption Kinetics)

Time-monitored adsorption of Pd²⁺ and Pt⁴⁺ by SH—TPBₓ was also performed in single metal ion solutions at a pH of 2 for Pd²⁺ and at a pH of 4 for Pt⁴⁺. The results showed that Pd²⁺ was quickly isolated to in an equilibrium state within just 10 minutes after adsorption (FIG. 11A). Meanwhile, equilibrium adsorption for Pt⁴⁺ was achieved after about 60 minutes (FIG. 11B). These kinetic equilibrium data are more excellent than most adsorbents known for Pd²⁺, Pt⁴⁺, or both. The saturation time of Pd²⁺ according to the results in FIGS. 10A and 10B shows a very fast result.

The parameters derived from the nonlinear fitting of the kinetic and isotherm models for Pd²⁺ and Pt⁴⁺ sequestration by SH—TPBₓ are listed in Table 2 below.

$$\begin{matrix}{q}_{t} = {q}_{e} ( 1 - {e}^{- {k}_{1} t} ) & ( 7 ) \\ {q}_{t} = \frac{{k}_{2} {q}_{e}^{2} t}{1 + {k}_{2} {q}_{e} t} & ( 8 )\end{matrix}$$

TABLE 2

| | Parameter Value | |
|---|---|---|
| Kinetic model | Pd2+ | Pt4+ |
| Pseudo-first order | | |
| k₁, (min⁻¹) | 3.745 | 45.445 |
| qₑ, mg g⁻¹ | 204.972 | 0.0873 |
| R² | 1.000 | 0.979 |
| Pseudo-second order | | |
| k₂, (g mg⁻¹min⁻¹) | 0.154 | 0.00265 |
| qₑ, mg g⁻¹ | 206.407 | 49.965 |
| R² | 1.000 | 0.994 |
| q_{e,experimental},mg g⁻¹ | 206 | 46 |
| | Parameter Value | |
| Isotherm model | Pd2+ | Pt4+ |
| Freundlich | | |
| K_{F}, (mg g⁻¹) (L mg⁻¹)^{-1/n} | 141.192 | 22.387 |
| 1/n | 0.181 | 0.214 |
| R² | 0.942 | 0.857 |
| Langmuir | | |
| K_{L}, (L mg⁻¹) | 0.098 | 0.237 |
| qₘ, mg g⁻¹ | 382.729 | 73.130 |
| R² | 0.908 | 0.991 |
| Hill | | |
| qₘ, mg g⁻¹ | 560.187 | 73.360 |
| n_{H} | 0.406 | 0.973 |
| K_{H}, (mg L⁻¹)ⁿ^{_{H}} | 4.425 | 4.080 |
| R² | 0.924 | 0.991 |
| Redlich-Peterson | | |
| α_{RP}, (L mg⁻¹)^{β} | 518.763 | 0.232 |
| β | 0.182 | 1.002 |
| K_{RP}, (mg g⁻¹)(L mg⁻¹) | 7.322 × 10⁷ | 17.110 |
| R² | 0.921 | 0.991 |
| qₑₓₚ, mg g⁻¹ | 370 | 70 |

From the Pd²⁺ and Pt⁴⁺ adsorption properties by SH—TPBₓ, the adsorption data were obtained by fitting them to pseudo-first (Eq. 7) and pseudo-second (Eq. 8) order kinetic models. Both models adequately implement the adsorption process (R²>0.9), but the pseudo-second-order model gives higher R2 values and the predicted equilibrium capacity qₑ was closely matched with the experimental data (see Table 2). This means that the sequestration of Pd²⁺ and Pt⁴⁺ by SH—TPBₓ occurs through chemisorption, and in other words, which means that the adsorption process involves substantial electron sharing to the extent that new strong chemical bonds are formed between the noble metal and the surface of SH—TPBₓ. The pseudo-second-order rate constants k₂ for Pd²⁺ and Pt⁴⁺ adsorption by SH—TPBₓ were estimated to be 0.154 g mg⁻¹ min⁻¹ (983 g mmol⁻¹ hr⁻¹) and 0.00265 g mg⁻¹ min⁻¹ (31 g mmol⁻¹ hr⁻¹), which represented the highest values obtained for known organic or organic-based adsorbents for these metals, respectively.

### (Adsorption Isotherm)

Adsorption isotherms for the sequestration of Pd²⁺ and Pt⁴⁺ by SH—TPBₓ were determined using single metal feed solutions of increasing concentration. The results showed that the adsorption capacities qₑ increase with increasing feed concentration Co, but eventually plateaus at some maximum where further increases in feed concentration do not substantially increase the adsorbed metal ions (FIGS. 10A and 10B). The results also showed that Pd²⁺ and Pt⁴⁺ are almost completely adsorbed by SH—TPBₓ at low concentrations of these ions in the feed, leading to near-equilibrium concentrations (Ce˜0) close to zero, thereby resulting in even higher qₑ values so that the isotherm curves near the origin appeared as a sharp vertical rise (FIGS. 10A and 10B). As a result, very high distribution coefficients (K_{D}>30,000 mL g⁻¹) were easily achieved.

Table 3 below describes the isotherm models used for the adsorption of Pd²⁺ and Pt⁴⁺ by SH—TPBₓ.

TABLE 3

| Model | Equation | Parameters | Eq. |
|---|---|---|---|
| Freundlich | qₑ = K_{F}Cₑ^{1/n} | n = Freundlich adsorption intensity | (9) |
| | | K_{F} = Langmuir constant for | |
| | | adsorption energy | |
| Langmuir | ${q}_{e} = \frac{{q}_{m} {K}_{L} {C}_{e}}{1 + {K}_{L} {C}_{e}}$ | qₘ = maximum adsorption capacity K_{L} = Langmuir constant for adsorption energy | (10) |
| Hill | ${q}_{e} = \frac{{q}_{m} {C}_{e}^{{n}_{H}}}{{K}_{H} + {C}_{e}^{{n}_{H}}}$ | qₘ = maximum monolayer adsorption capacity n_{H} = Hill cooperativity binding | (11) |
| | | coefficient | |
| | | K_{H} = Hill isotherm constant | |
| Redlich- Peterson (R-P) | ${q}_{e} = \frac{{K}_{RP} {C}_{e}}{1 + {α}_{RP} {C}_{e}^{β}}$ | α_{RP}, β, and K_{RP} are Redlich- Peterson isotherm constants | (12) |

Regarding Pd²⁺ and Pt⁴⁺ adsorption by SH—TPBₓ, nonlinear fitting of the isotherm plots was performed using the isotherm models listed in Table 3 above. All isotherm models adequately represent the adsorption profiles of both based on the R2 values. However, some appear to be better than others (Table 2).

For Pd²⁺, the Freundlich isotherm gives the highest correlation coefficient (R2-0.942), suggesting a heterogeneous adsorption surface. However, the adsorption capacity data was not properly represented at high Ce(FIG. 12A). Like the Freundlich plot, the Hill isotherm also overestimated qₑ (FIG. 12A, Table 2). Meanwhile, the Langmuir isotherm prediction of qₑ is in good agreement with the experimental data (FIG. 12A, Table 2). This means that monolayer adsorption is also a characteristic of Pd²⁺ adsorption by SH—TPBₓ. On this wise, a combination of Freundlich-type and Langmuir-type mechanisms appears to be at play, which is implied by the high correlation obtained for the Redlich-Peterson isotherm. The experimental maximum adsorption capacity qₑₓₚ of SH—TPBₓ for Pd²⁺ is about 370 mg g⁻¹ (3.477 mmol g⁻¹). When the thiol content is only 2.253 mmol g⁻¹, the adsorption of Pd²⁺ is understood to occur through various mechanisms: (1) two adjacent sulfur atoms (—S: Pd²⁺: S—) form a complex with a thiol group participating in two lone pairs of electrons (which can explain up to 65% of qₑₓₚ (240 mg g⁻¹ of adsorbed Pd²⁺)); (2) complex formation with two pairs of phenyl rings from two adjacent TPB moieties (—Ph₂—B⁻—Ph₂-Pd²⁺—Ph₂—B⁻—Ph₂—); and (3) complex formation with adjacent sulfur and TPB moieties (—S: Pd²⁺—Ph₂-B⁻—Ph₂—).

In the case of Pt⁴⁺ adsorption by SH—TPBₓ, it is understood that monolayer adsorption is the dominant mechanism due to the strong correlation (R2=0.991) and excellent agreement between the predicted and experimental results when fitting Langmuir isotherms. This is further supported by the Hill isotherm, which obtained a coupling coefficient close to 1 (nH=0.973). The qₑₓₚ for Pt⁴⁺ is approximately 70 mg g⁻¹ (0.359 mmol g⁻¹). The sequestration of Pt⁴⁺ is understood to be due to complex formation with thiol groups at a molar ratio of a thiol to Pt⁴⁺ of 4:1, which may require a thiol group content of up to 1.436 mmol g⁻¹. Thiols have been difficult to use because of the geometric structure and proximity requirements for successful formation of metal-ligand complexes. For chemisorption through charge neutralization to occur, Pt⁴⁺ should be within the reactive coordination distance of the four electron donating groups. In SH—TPBₓ, these demands can be met due to the high thiol content of the tightly woven tetraphenylboron monomers. Moreover, though the requirements for meeting the coordination are stringent, and the spatial arrangement and distribution of thiol groups are random, SH—TPBₓ may be a very excellent adsorbent, even at low concentrations of Pt⁴⁺, such as in autocatalytic leaching solutions.

### (Adsorption Thermodynamics)

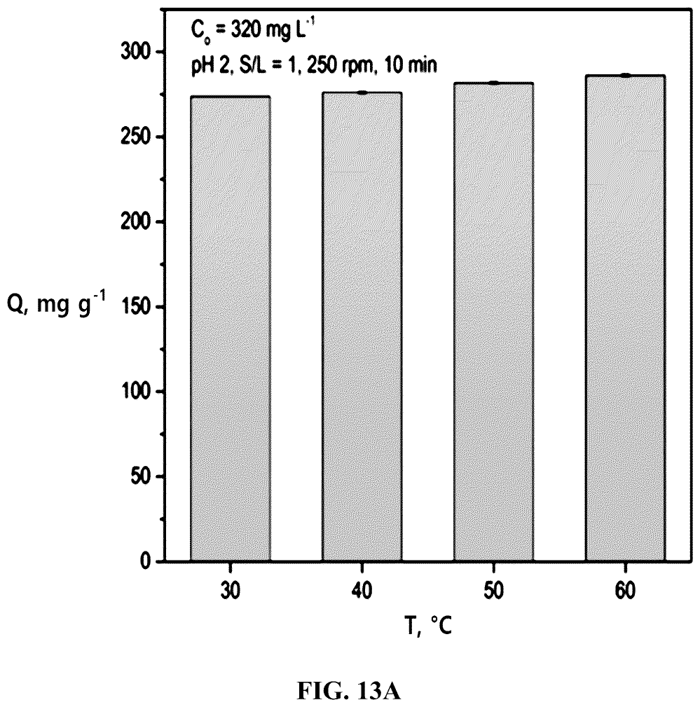

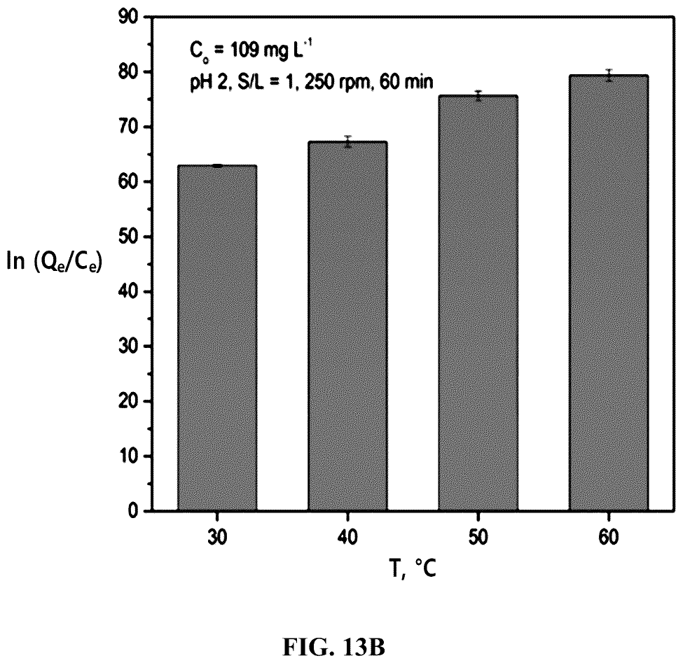

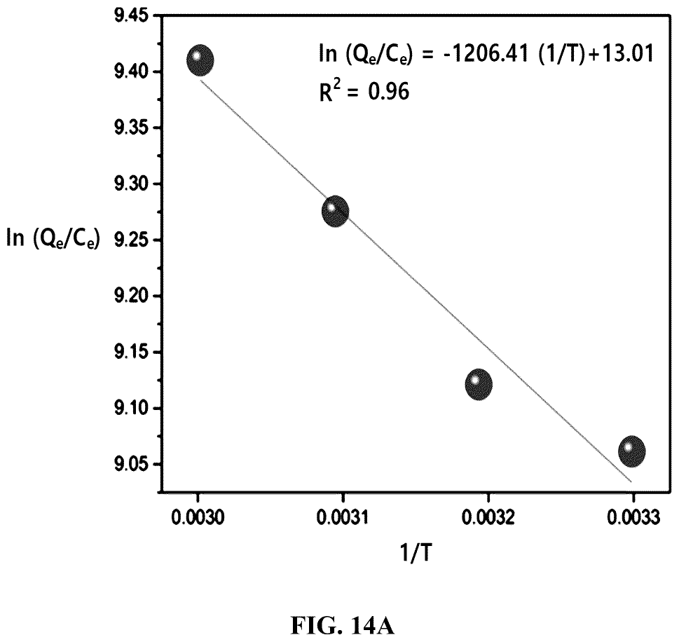

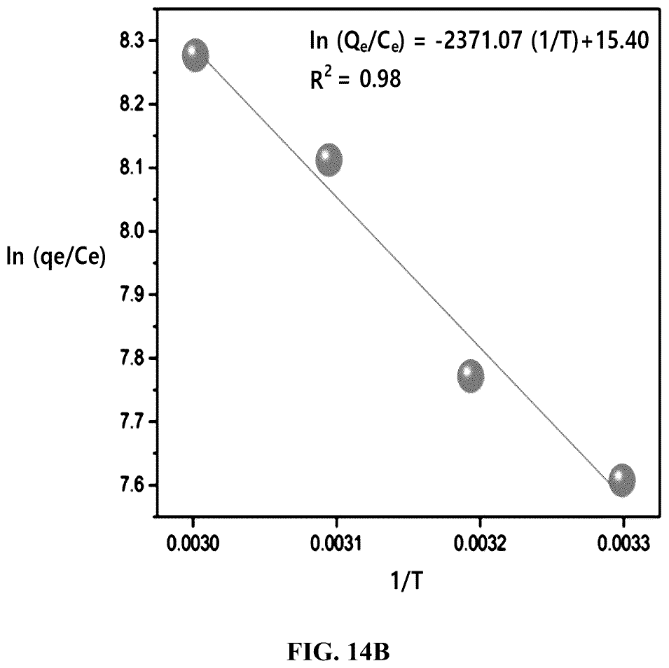

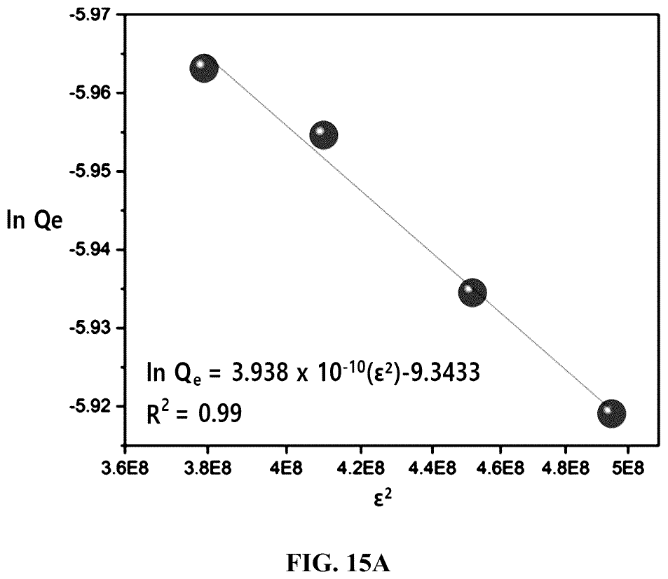

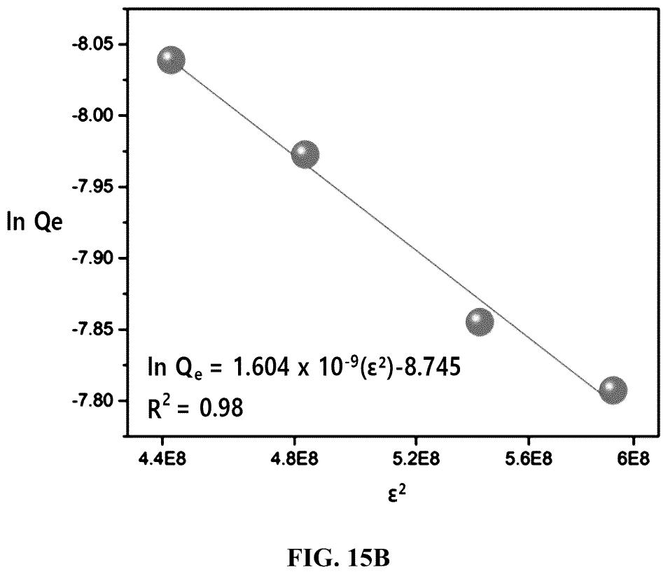

FIGS. 13A and 13B are graphs evaluating the adsorption capacities of SH—TPBₓ at different temperatures for Pd²⁺ (FIG. 13A) and Pt⁴⁺ (FIG. 13B), FIGS. 14A and 14B are results of the van′t Hoff equation in which the adsorption capacity data is linearized, and FIGS. 15A and 15B show Dubinin-Radushkevich plots [Adsorption conditions: S/L=1, 10 minutes for Pd²⁺, and 60 minutes and 250 rpm for Pt⁴⁺].

A noticeable change in the adsorption capacity of SH—TPBₓ for Pd²⁺ and Pt⁴⁺ was observed when changing the operating temperature. For both metal ions, uptake increases as temperature increases (FIGS. 13A and 13B), which is a characteristic observed in the chemical adsorption process. Such a behavior may be sensed kinetically by heat that activates the sorbate-sorbent interaction. Thermodynamically, this means that the adsorption process is endothermic. This is further confirmed when the adsorption data are fitted to the linearized van′t Hoff equation (Equation S1 below, FIGS. 14A and 14B), and thus positive values for the standard enthalpy (ΔH°) appear (see Table 4 below).

(Equation S1) Standard enthalpy (ΔH°) of the reaction formula

$$ln \frac{{q}_{e}}{{C}_{e}} = \frac{Δ {S}^{o}}{R} - \frac{Δ {H}^{o}}{RT} \qquad ( S1 )$$

Meanwhile, the positive value obtained for the standard entropy of reaction (ΔS°) means that the adsorption process leads to increased disorder at the sorbent-sorbate interface, and this disorder appears sufficiently widespread to occur spontaneously at the temperature (ΔG°<0) that is taken into account by the adsorption process (see Table 4 below). Table 4 describes thermodynamic parameters [Conditions: pH 2, 10 min, and Co=320 ppm for Pd²⁺; pH 4, 60 min, and Co=109 ppm for Pt⁴⁺; and 250 rpm, S/L=1.0] for Pd²⁺ and Pt⁴⁺ adsorption by SH—TPBₓ at different temperatures.

TABLE 4
Pd²⁺

| Temperature, | ΔS°, | ΔH°, | ΔG°, |
|---|---|---|---|
| ° C. | J mol⁻¹ K⁻¹ | KJ mol⁻¹ | KJ mol⁻¹ |
| 30 | 108.165 | 10.030 | −22.838 |
| 40 | 108.165 | 10.030 | −23.747 |
| 50 | 108.165 | 10.030 | −24.920 |
| 60 | 108.165 | 10.030 | −26.064 |

Pt⁴⁺

| Temperature, | ΔS°, | ΔH°, | ΔG°, |
|---|---|---|---|
| ° C. | J mol⁻¹ K⁻¹ | KJ mol⁻¹ | KJ mol⁻¹ |
| 30 | 128.036 | 19.713 | −19.173 |
| 40 | 128.036 | 19.713 | −20.233 |
| 50 | 128.036 | 19.713 | −21.794 |
| 60 | 128,036 | 19.713 | −22.925 |

Thermodynamic data were further analyzed using the Dubinin-Radushkevich (D-R) isotherms (Equations S2 to S4 below). Additional equation fitting analysis of the thermally altered adsorption data using the Dubinin-Radushkevich (D-R) isotherms (where In qₑ was plotted against the Polanyi potential energy (ε²)) showed that the average free energy of adsorption (E˜ 35.62 kJ mol⁻¹ for Pd²⁺ and 17.65 kJ mol⁻¹ for Pt⁴⁺) is consistent with chemisorption (E >8 KJ mol⁻¹).

$$\begin{matrix}ln {q}_{e} = ln {q}_{m} - {βε}^{2} & ( S2 ) \\ ε = RT ln ( 1 + \frac{1}{{C}_{e}} ) & ( S 3 ) \\ E = \frac{1}{\sqrt{- 2 β}} & ( S 4 )\end{matrix}$$

In Equation S1 above among Equations S2 to S4 above, ε² is the Polanyi potential energy, β is a constant related to the average free energy of adsorption per mole of the adsorption target material, and E is the average free energy of adsorption.

The plots of Equation S2 (In qₑ versus ε²) shown in FIGS. 15A and 15B yield high correlation coefficients (R2>0.9) to provide estimation values for β and corresponding values for E.

### (Regeneration and Reuse)

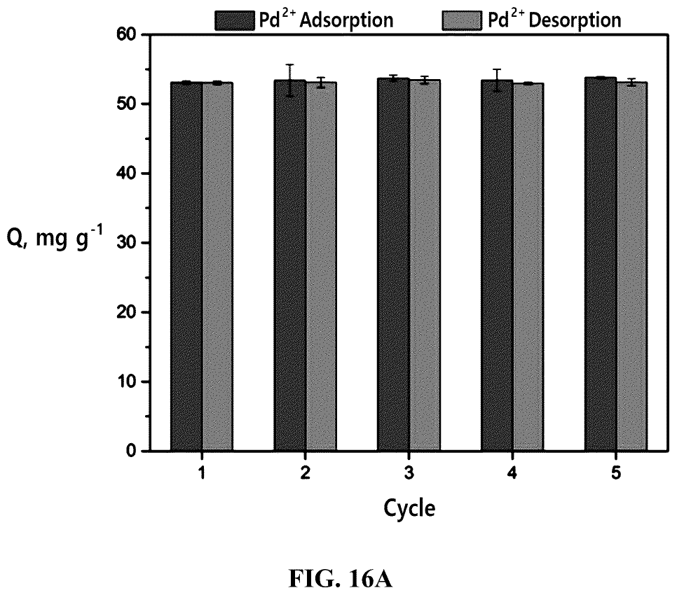

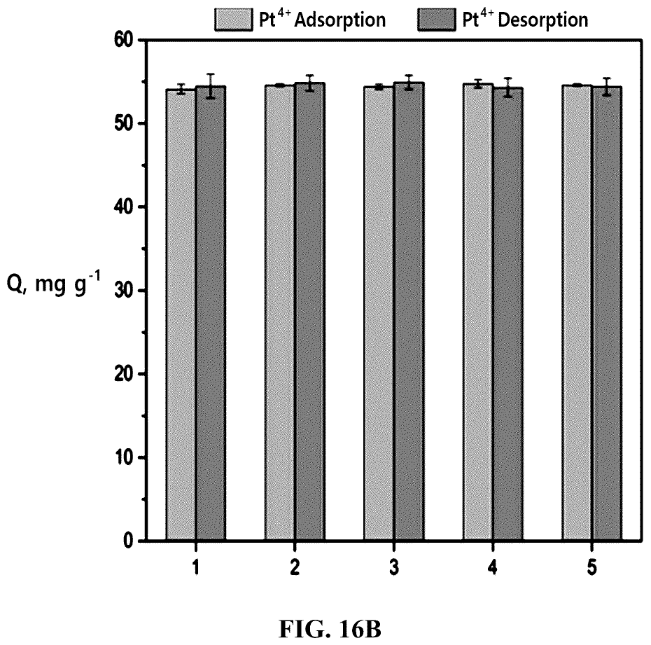

FIGS. 16A and 16B show graphs evaluating the adsorption-desorption capacity of five reuse cycles [Adsorption conditions: 40° C., 250 rpm, S/L=1, 10 minutes for Pd²⁺ and 60 minutes for Pt⁴⁺; Desorption conditions: 1M thiourea in 2M HCl as an absorbent, 40° C., 250 rpm, S/L=1, 24 hours] on single metal ion feed solutions comprising Pd²⁺ (up to 126.23 mg/L⁻¹ at a pH of 1) (FIG. 16A) and Pt⁴⁺ (up to 83.49 mg/L⁻¹ at a pH of 4) (FIG. 16B).

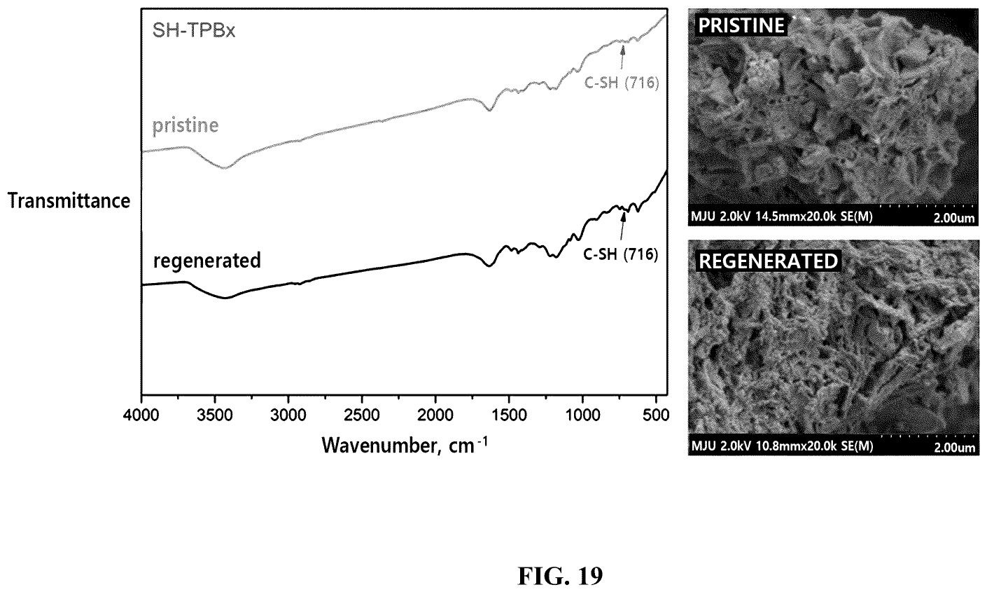

The adaptability of SH—TPBₓ to repeated use was evaluated by 5 cycles of adsorption-desorption experiments using a single metal feed solution and 1 M thiourea in 2 M HCl as a lixiviant. The results confirmed that the adsorption capacities of SH—TPBₓ for Pd²⁺ and Pt⁴⁺ were essentially maintained, and the metal ions in the lixiviant were almost completely desorbed in each cycle (FIGS. 16A and 16B). This means that the adsorption site of SH—TPBₓ is not changed as the adsorbed metal is chemically induced and exfoliated, and that the continued interaction of SH—TPBₓ with the target metal ions is physically and chemically practicable during the entire adsorbent reactivation process. FIG. 19 is FTIR spectra and SEM images of the pristine state and regenerated SH—TPBₓ after the 5th adsorption-desorption cycle, and there is substantially no change in the functional group composition and surface morphology when comparing the pristine state and regenerated SH—TPBₓ. From this, it was confirmed that even if SH—TPBₓ is reused, it can continue to function optimally under the same adsorption-desorption conditions.

### (Performance in Simulated Autocatalyst Leachate)

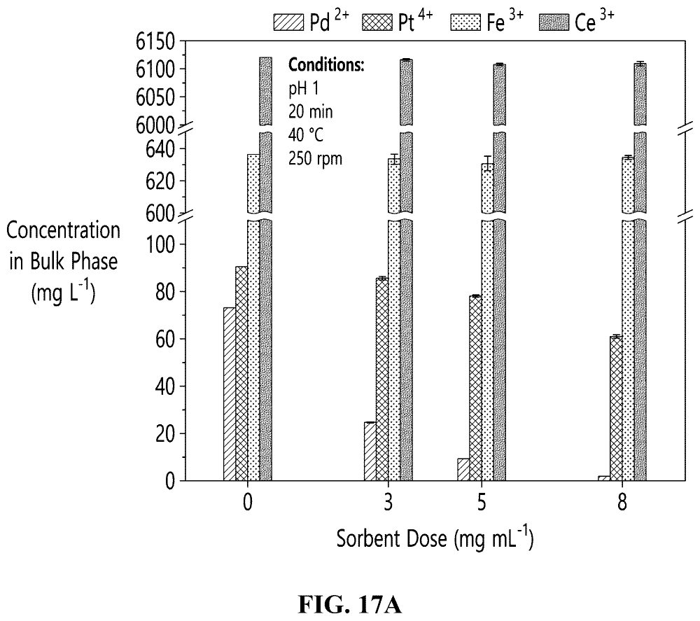

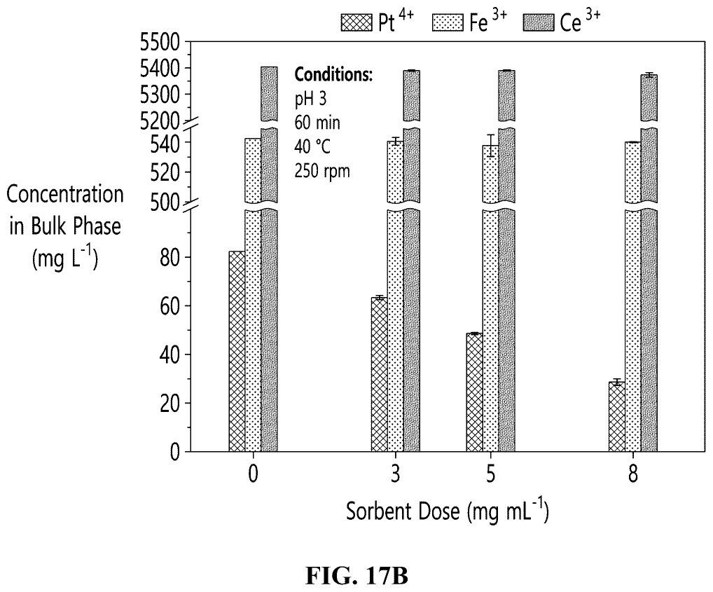

FIG. 17A shows a concentration profile of metal ions in simulated autocatalyst leachate containing Pd²⁺, Pt⁴⁺, Fe³⁺, and Ce³⁺ after adsorption using different doses (mg/mL⁻¹) of SH—TPBₓ at a pH of 1; and FIG. 17B shows a concentration profile of metal ions in simulated autocatalyst leachate containing Pt⁴⁺, Fe³⁺, and Ce³⁺ after adsorption using different doses (mg/mL⁻¹) of SH—TPBₓ at a pH of 3.

As the adsorption performance of Pd²⁺ and Pt⁴⁺ for single metal ion solutions was confirmed, the effect of adsorption of such metal ions by SH—TPBₓ on simulated autocatalytic leaching waste was subsequently evaluated. At pH conditions and contact times where Pd²⁺ is intended to be recovered first, followed by Pt⁴⁺, and where effective and selective sequestration is expected, the adsorbent dose (S/L˜3,5,8) for the concentration of each of such metal ions has been studied. On this wise, two dose-response evaluations were performed: (1) Pd²⁺ recovery at a pH of 1 after adsorption within 20 minutes from a feed containing Pd²⁺, Pt⁴⁺, Fe³⁺, and Ce³⁺; and (2) Pd²⁺ recovery at a pH of 3 after adsorption within 60 minutes from a feed containing Pt⁴⁺, Fe³⁺, and Ce³⁺. The results show that, under the operating conditions used, the concentration of Pd²⁺ decreases significantly with increasing adsorbent capacity, up to a point where the Pd²⁺ concentration in the simulated leachate becomes essentially zero at S/L=8, whereas the concentrations of other metal ions decrease very slightly (FIG. 17A). Similarly, the concentration of Pt⁴⁺ decreased significantly with increasing adsorbent dose when adsorption was performed under certain operating conditions (FIG. 17B).

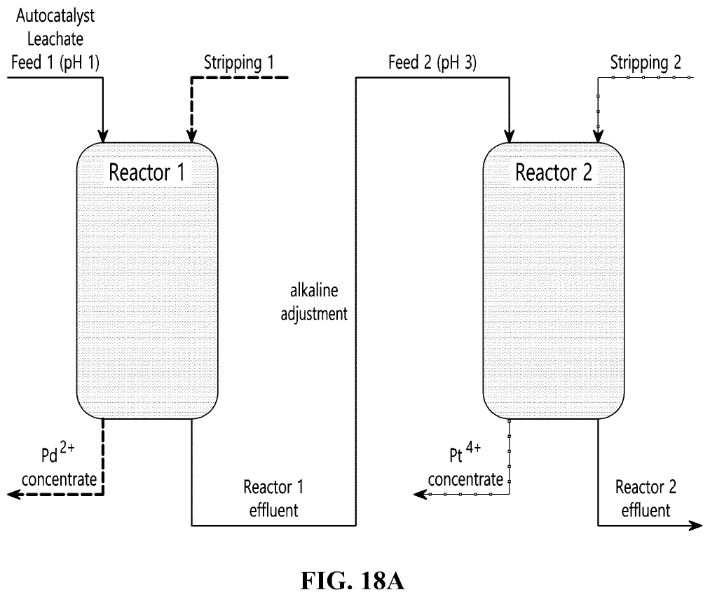

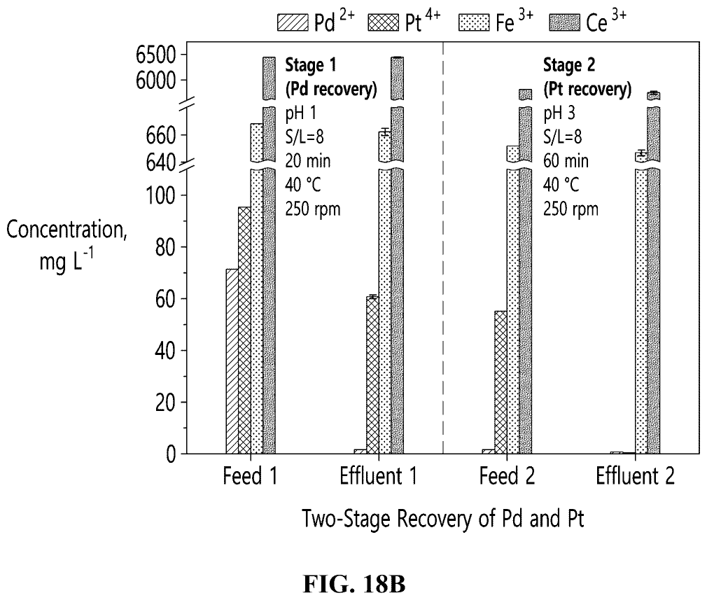

FIG. 18A shows a process flow proposed for two-stage batch recovery operation and FIG. 18B shows concentration profiles of metal ions in simulated autocatalyst leachate containing Pd²⁺ Pt⁴⁺, Fe³⁺, and Ce³⁺ after performing adsorption at a pH of 1 for 20 minutes (step 1) and after performing adsorption at a pH of 3 for 60 minutes (step 2).

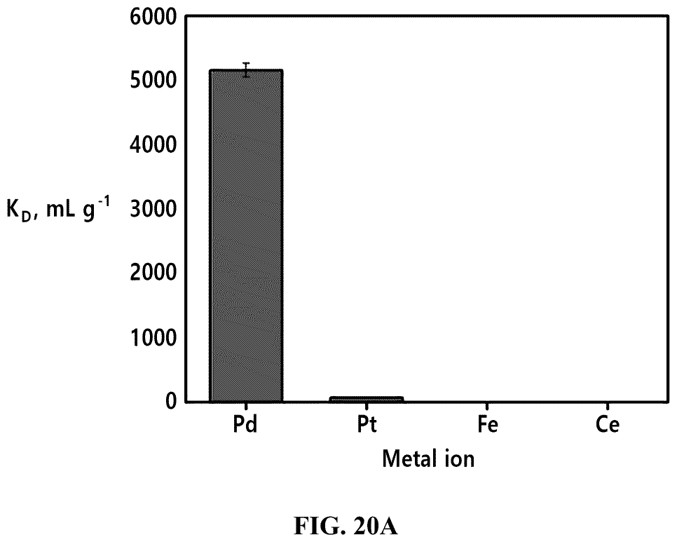

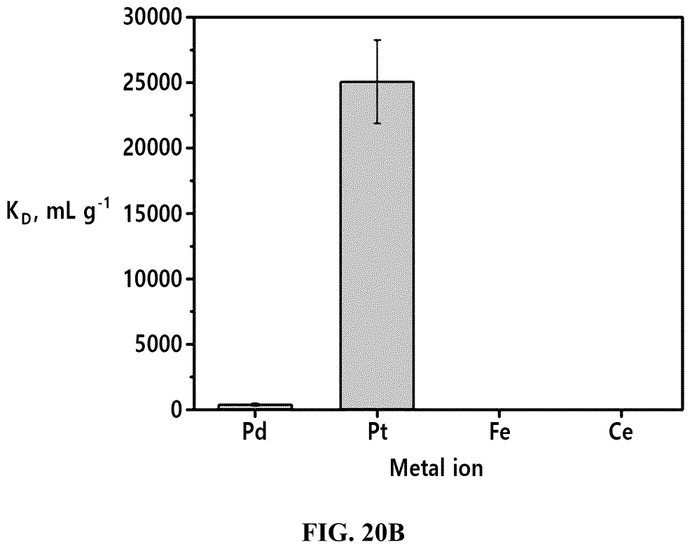

FIGS. 20A and 20B show distribution coefficient (K_{D}) profiles of metal ions in SH—TPBₓ applied to simulated autocatalyst leachates after performing adsorption at a pH of 1 for 20 minutes at S/L=8 (FIG. 20A) and after performing adsorption at a pH of 3 for 60 minutes at S/L=8 (FIG. 20B) [General conditions: 250 rpm, 40° C.].

Results from the dose-response evaluation guarantee the evaluation of a two-stage batch recovery process including pH and time constraint conditions. Pd²⁺ was isolated in the first step (reactor 1), and after the elution water was adjusted to an appropriate pH, the remaining Pt⁴⁺ was isolated in the second step (reactor 2) using a predetermined dose of freshly provided SH—TPBₓ (FIG. 18A). The results showed that such a strategy worked as intended, allowing Pd²⁺ and Pt⁴⁺ to be virtually completely isolated (FIG. 18B). The K_{D} values also proved the selective adsorption of Pd²⁺ (K_{D} of up to 5000 mL g⁻¹) in the first step and Pt⁴⁺ (K_{D} of up to 25,000 mL g⁻¹) in the second step, which were at least 70 times larger than those of the next target metal ions in the mixture (FIGS. 20A and 20B).

As described above, the present disclosure has been described with reference to the illustrative drawings, but the present disclosure is not limited to the embodiments and drawings disclosed in this specification, and it is obvious that various modifications may be made by those skilled in the art within the scope of the technical idea of the present disclosure. In addition, although the operational effects according to the configuration of the present disclosure were not explicitly described and explained while explaining the embodiments of the present disclosure above, it is natural that the predictable effects due to the relevant configuration should also be recognized.

1. A hyper-crosslinked polymer compound of thiolated tetraphenylboron.

2. The hyper-crosslinked polymer compound of thiolated tetraphenylboron of claim 1,
wherein the hyper-crosslinked polymer compound of thiolated tetraphenylboron is one in which a plurality of structural units of the following Formula 1 are crosslinked: 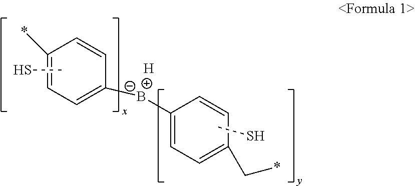
In Formula 1, x and y are each independently an integer of 0 to 4, x+y=4, * represents a bond with * in another neighboring structural units represented by Formula 1 above, 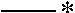
connected to the benzene ring is connected to 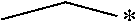 [SMILES: *CC]
connected to the benzene ring of another neighboring structural units represented by Formula 1 above, and 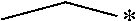
connected to the benzene ring is connected to 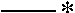 [SMILES: *C]
connected to the benzene ring of another neighboring structural units represented by Formula 1 above.

3. The hyper-crosslinked polymer compound of thiolated tetraphenylboron of claim 1,
wherein the hyper-crosslinked polymer compound of thiolated tetraphenylboron is synthesized by sulfonating a tetraphenylboron hyper-crosslinked polymer to graft a sulfone group, and then substituting the sulfone group with a thiol group.

4. The hyper-crosslinked polymer compound of thiolated tetraphenylboron of claim 1,
wherein the hyper-crosslinked polymer compound is a porous material.

5. The hyper-crosslinked polymer compound of thiolated tetraphenylboron of claim 1,
wherein the hyper-crosslinked polymer compound has a BET surface area of 200 m² g⁻¹ to 1000 m² g⁻¹.

6. A platinum group metal adsorbent comprising a hyper-crosslinked polymer compound of thiolated tetraphenylboron.

7. The platinum group metal adsorbent of claim 6, wherein the hyper-crosslinked polymer compound of thiolated tetraphenylboron is one in which a plurality of structural units of the following Formula 1 are crosslinked: 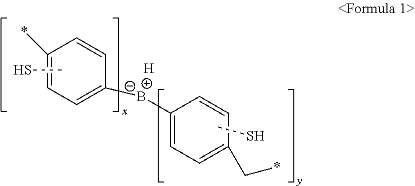
In Formula 1, x and y are each independently an integer of 0 to 4, x+y=4, * represents a bond with * in another neighboring structural units represented by Formula 1 above, 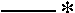
connected to the benzene ring is connected to 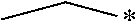 [SMILES: *CC]
connected to the benzene ring of another neighboring structural units represented by Formula 1 above, and 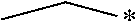
connected to the benzene ring is connected to 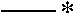 [SMILES: *C]
connected to the benzene ring of another neighboring structural units represented by Formula 1 above.

8. The platinum group metal adsorbent of claim 6, wherein the hyper-crosslinked polymer compound of thiolated tetraphenylboron performs chemical adsorption.

9. The platinum group metal adsorbent of claim 6, wherein the hyper-crosslinked polymer compound of thiolated tetraphenylboron performs single layer adsorption.

10. A method for synthesizing a hyper-crosslinked polymer compound of thiolated tetraphenylboron, the method comprising steps of:
hyper-crosslinking a tetraphenylboron sodium salt to obtain hyper-crosslinked tetraphenylboron;
sulfonating hyper-crosslinked tetraphenylboron; and
substituting a sulfone group in sulfonated hyper-crosslinked tetraphenylboron with a thiol group to obtain a hyper-crosslinked polymer compound of thiolated tetraphenylboron.
